(19) United States
(12) Patent Application Publication
(10) Pub. No.: US 2026/0169877 A1
(43) Pub. Date: Jun. 18, 2026

(54) Computer System and Network Customization and Management Using Calibration of Data Analysis Models Via Small Scale Geo Tests With User Level Data

(71) Applicant: Google LLC, Mountain View, CA (US)

(72) Inventors: David Xi-Kuan Chan, Short Hills, NJ (US); Kyra Krishan Singh, Brooklyn, NY (US); Penelope Wancie Chu, Millbrae, CA (US)

(21) Appl. No.: 18/984,804

(22) Filed: Dec. 17, 2024

(51) Int. Cl. G06F 11/263; G06F 11/22

(52) U.S. Cl. CPC G06F 11/263; G06F 11/2242

(57) ABSTRACT

Example embodiments of the present disclosure provide an example method for managing computer systems and networks using calibration of data analysis models via small scale geo tests with user level data. The example method includes generating and utilizing small-scale geos and user level data-driven weight-oriented test results with calibration of data analysis model results. The data analysis model results can be generated and calibrated with weight-oriented tests using touchpoints in datasets with the user level data which corresponds to the small-scale geos.

### FIELD

The present disclosure relates generally to systems and methods for customizing and managing computer systems and networks using calibration of data analysis models via small scale geo tests with user level data.

### BACKGROUND

Computing systems manage complex assortments of data of different types being exchanged via networks, and distributed devices communicatively connected thereto. Distributing communications, and packages therefore, between the computing systems, the networks, and the distributed devices is managed based on information representing effectiveness of data communicated via various types of mediums. Components of the information that model effectiveness of the data at large scales enable management of the data, and utilization thereof. The management includes performing and controlling various computing and/or networking related functions and configurations that are utilized to manage future communications.

### SUMMARY

Aspects and advantages of embodiments of the present disclosure will be set forth in part in the following description, or can be learned from the description, or can be learned through practice of the embodiments.

In one example aspect, the present disclosure provides for an example computer-implemented method. The example computer-implemented method includes performing a control geo-experiment and a test geo-experiment to find an incrementality value, where the control geo-experiment has a first channel on and a second channel on, and where the test geo-experiment has the first channel on and the second channel off. The method also includes determining a likelihood of the incrementality value being applicable to a multi-touch attribution (MTA) result. The method also includes determining a calibration lever based at least in part on the likelihood. The method also includes determining an MTA calibration of the MTA result based at least in part on the incrementality value, the calibration lever, and results from the control geo-experiment and the test geo-experiment.

In some embodiments of the example method, the calibration lever is determined based at least in part on at least one of: i) a level of similarity between a control market may include corresponding first MTA credits and a test market may include corresponding second MTA credits; ii) a degree of resemblance between the test market used to establish the calibration lever and a non-testing market requiring calibration; iii) a level of freshness of the MTA calibration; or iv) a predicted probability of future MTA calibrations being different due to market trends.

In some embodiments of the example method, calculating another MTA calibration based at least in part on the MTA result, a fully calibrated MTA, the incrementality value, and another calibration lever.

In some embodiments of the example method, calculating a fully calibrated MTA result by multiplying the MTA result by the incrementality value; calculating a difference of the MTA result subtracted by the fully calibrated MTA result; and calculating another MTA calibration by subtracting, from the MTA result, a product of another calibration lever and the difference.

In some embodiments of the example method, the control geo-experiment is performed for a first geo, the test geo-experiment is performed for a second geo, and the first geo and the second geo are associated with a similarity metric that is less than a threshold.

In some embodiments of the example method, performing the control geo-experiment and the test geo-experiment occurs within a threshold time from previously performing a prior control geo-experiment and a prior test geo-experiment.

In some embodiments of the example method, performing the control geo-experiment by turning the first channel on and the second channel on, and then turning the second channel artificially off.

In some embodiments of the example method, determining the incrementality value by comparing a first credit associated with the first channel in the control geo-experiment and a second credit associated with the first channel in the test geo-experiment.

In an example aspect, the present disclosure provides for a computing system. The computing system also includes one or more processors. The system also includes one or more transitory or non-transitory computer-readable media storing instructions that are executable to cause the one or more processors to perform operations, the operations may include: performing a control geo-experiment and a test geo-experiment to find an incrementality value, where the control geo-experiment has a first channel on and a second channel on, and where the test geo-experiment has the first channel on and the second channel off; determining a likelihood of the incrementality value being applicable to a multi-touch attribution (MTA) result. The system also includes determining a calibration lever based at least in part on the likelihood; and determining an MTA calibration of the MTA result based at least in part on the incrementality value, the calibration lever, and results from the control geo-experiment and the test geo-experiment.

In some embodiments of the example system, the calibration lever is determined based at least in part on at least one of: i) a level of similarity between a control market may include corresponding first MTA credits and a test market may include corresponding second MTA credits; ii) a degree of resemblance between the test market used to establish the calibration lever and a non-testing market requiring calibration; iii) a level of freshness of the MTA calibration; or iv) a predicted probability of future MTA calibrations being different due to market trends.

In some embodiments of the example system, calculating another MTA calibration based at least in part on the MTA result, a fully calibrated MTA, the incrementality value, and another calibration lever.

In some embodiments of the example system, calculating a fully calibrated MTA result by multiplying the MTA result by the incrementality value; calculating a difference of the MTA result subtracted by the fully calibrated MTA result; and calculating another MTA calibration by subtracting, from the MTA result, a product of another calibration lever and the difference.

In some embodiments of the example system, the control geo-experiment is performed for a first geo, the test geo-experiment is performed for a second geo, and the first geo and the second geo are associated with a similarity metric that is less than a threshold.

In some embodiments of the example system, Performing the control geo-experiment and the test geo-experiment occurs within a threshold time from previously performing a prior control geo-experiment and a prior test geo-experiment.

In some embodiments of the example system, performing the control geo-experiment by turning the first channel on and the second channel on, and then turning the second channel artificially off.

In some embodiments of the example system, determining the incrementality value by comparing a first credit associated with the first channel in the control geo-experiment and a second credit associated with the first channel in the test geo-experiment.

In an example aspect, the present disclosure provides for one or more non-transitory computer readable media storing instructions that are executable by one or more processors to perform operations. The one or more non-transitory computer readable media storing instructions also includes performing a control geo-experiment and a test geo-experiment to find an incrementality value, where the control geo-experiment has a first channel on and a second channel on, and where the test geo-experiment has the first channel on and the second channel off. The instructions also includes determining a likelihood of the incrementality value being applicable to a multi-touch attribution (MTA) result. The instructions also includes determining a calibration lever based at least in part on the likelihood. The instructions also includes determining an MTA calibration of the MTA result based at least in part on the incrementality value, the calibration lever, and results from the control geo-experiment and the test geo-experiment.

In some embodiments of the one or more non-transitory computer readable media, the calibration lever is determined based at least in part on at least one of: i) a level of similarity between a control market may include corresponding first MTA credits and a test market may include corresponding second MTA credits; ii) a degree of resemblance between the test market used to establish the calibration lever and a non-testing market requiring calibration; iii) a level of freshness of the MTA calibration; or iv) a predicted probability of future MTA calibrations being different due to market trends.

In some embodiments of the one or more non-transitory computer readable media, calculating another MTA calibration based at least in part on the MTA result, a fully calibrated MTA, the incrementality value, and another calibration lever.

In some embodiments of the one or more non-transitory computer readable media, the MTA result includes a time to event data driven attribution (TEDDA) result.

In one example aspect, the present disclosure provides for an example computer-implemented method. The example computer-implemented method includes accessing, by a computing system, a datastore may include channel identifiers individually representing a media channel; generating, by the computing system, weights of the media channels; generating, by the computing system, calibrated data analysis model results by, for individual ones of the data analysis model results: generating a calibration lever from among calibration levers associated with a corresponding test geo, the calibration lever being associated with a corresponding test channel; executing computations may include the calibration lever, and the corresponding weight of the corresponding test channel; and identifying a result of the computations as the corresponding calibrated data analysis model result. The method also includes modifying, by the computing system, fields of a data structure representing sets of channel characteristics, individual ones of the channel characteristics being associated with the corresponding calibrated data analysis model result within a non-testing period.

In some embodiments of the example method, a first geo with which a non-testing data analysis model result utilized to generate the calibrated data analysis model results is associated may include a first city, a second geo with which a fully calibrated result utilized to generate the calibrated data analysis model results is associated may include a second city, and the first city and the second city are associated with a similarity metric that is less than a threshold.

In some embodiments of the example method, for individual ones of the calibration levers: defining the corresponding weight of the corresponding test channel as a calibration factor; calculating a fully calibrated result by multiplying a non-testing data analysis model result by the calibration factor; generating, as a multiplier, a difference from the non-testing data analysis model result being subtracted by the fully calibrated result; and calculating, as the corresponding calibrated data analysis model result, a calibrated channel result by subtracting the non-testing data analysis model result by a product of the corresponding calibration lever and the multiplier.

In some embodiments of the example method, individual ones of the calibration levers are set based at least in part on at least one of: i) a level of similarity between a control destination may include corresponding first data analysis model credits and a test destination may include corresponding second data analysis model credits; ii) a degree of resemblance between the test destination used to establish the corresponding calibration lever and a non-testing destination requiring calibration; iii) a level of freshness of the calibrated data analysis model results; or iv) a predicted probability of future calibrated data analysis model results being different.

In some embodiments of the example method, generating, by the computing system, parameters of the media channels by, for individual ones of combinations of the media channels: initializing, by the computing system, the data structure; populating, by the computing system, the data structure with first data analysis model credits in a first group generated from first electronic communications associated with a first geo, modified first data analysis model credits in a modified first group generated from modified first electronic communications associated with the first geo, and second data analysis model credits in a second group generated from second electronic communications associated with a second geo, the first group may include additional electronic communications supplemental to the modified first electronic communications in a modified first group; populating, by the computing system, the data structure with channel subcombinations respectively corresponding to the first data analysis model credits, the modified first data analysis model credits, and the second data analysis model credits; and calculating, by the computing system, the parameters of the media channels associated with corresponding groups of data analysis model credits.

In an example aspect, the present disclosure provides for a computing system. The computing system also includes one or more processors. The system also includes one or more transitory or non-transitory computer-readable media storing instructions that are executable to cause the one or more processors to perform operations, the operations may include: accessing, by a computing system, a datastore may include channel identifiers individually representing a media channel; obtaining session data descriptive of a plurality of user sessions, the plurality of user sessions respectively may include an interaction with an input element rendered at a user device and a request for a resource associated with the input element; generating, by the computing system, utilizing the session data, incrementalities of the media channels; generating, by the computing system, calibrated multi-touch attribution (MTA) results by, for individual ones of the calibrated MTA results: generating a calibration lever from among calibration levers associated with a corresponding test geo, the calibration lever being associated with a corresponding test channel; executing computations with the calibration lever and with the corresponding incrementality of the corresponding test channel; and identifying a result of the computations as the corresponding calibrated MTA result. The system also includes modifying, by the computing system, fields of a data structure representing sets of channel characteristics, individual ones of the channel characteristics being associated with the corresponding calibrated MTA result within a non-testing period and being utilized to populate a user interface with one or more selected input elements.

In some embodiments of the example system, a first geo with which a non-testing MTA result utilized to generate the calibrated MTA results is associated may include a first city and a second geo with which a fully calibrated result utilized to generate the calibrated MTA results is associated may include a second city, and the first city and the second city are associated with a similarity metric that is less than a threshold.

In some embodiments of the example system, individual ones of the calibration levers reflect, as the corresponding incrementality of the corresponding test channel, a percentage of a time to event data driven attribution (TEDDA) result that is predicted to be applicable to the corresponding test channel.

In some embodiments of the example system, for individual ones of the calibration levers: defining the corresponding incrementality of the corresponding test channel as a calibration factor; calculating a fully calibrated result by multiplying a non-testing time to event data driven attribution (TEDDA) result by the calibration factor; generating, as a multiplier, a difference from the non-testing TEDDA result being subtracted by the fully calibrated result; and calculating, as the corresponding calibrated MTA result, a calibrated channel result by subtracting the non-testing TEDDA result by a product of the corresponding calibration lever and the multiplier.

In some embodiments of the example system, individual ones of the calibration levers are set based at least in part on at least one of: i) a level of similarity between a control market may include corresponding first MTA credits and a test market may include corresponding second MTA credits; ii) a degree of resemblance between the test market used to establish the corresponding calibration lever and a non-testing market requiring calibration; iii) a level of freshness of the calibrated MTA results; or iv) a predicted probability of future calibrated MTA results being different due to market trends

In some embodiments of the example system, for individual ones of combinations of the media channels, individual ones of touchpoints to which MTA credits are assigned are associated with a first channel, a second channel, or a third channel.

In some embodiments of the example system, For individual ones of combinations of the media channels, individual ones of touchpoints corresponding to a control geo are associated with a different channel than a first channel or a second channel with which individual ones of modified touchpoints corresponding to the control geo are associated.

In some embodiments of the example system, for individual ones of combinations of the media channels, individual ones of touchpoints corresponding to a test geo are associated with a same channel from among any of the media channels with which individual ones of other touchpoints corresponding to a control geo are associated.

In some embodiments of the example system, for individual ones of combinations of the media channels, individual ones of touchpoints corresponding to a control geo are associated with a same channel from among any of the channels with which individual ones of initial touchpoints corresponding to the control geo are associated.

In some embodiments of the example system, generating the calibrated MTA results is performed within a threshold time from previously generating prior calibrated MTA results.

In some embodiments of the example system, generating, by the computing system, a new calibrated MTA result by: generating a new calibration lever associated with a new geo, the new calibration lever being associated with a new channel; executing computations with the new calibration lever and with a new incrementality of the new channel; and identifying a result of the computations as the new calibrated MTA result; and modifying, by the computing system, a corresponding field of the data structure representing a new channel characteristic corresponding to the new calibrated MTA result within a non-testing period.

In an example aspect, the present disclosure provides for one or more non-transitory computer readable media storing instructions that are executable by one or more processors to perform operations. The one or more non-transitory computer readable media storing instructions also includes accessing, by a computing system, a datastore may include channel identifiers individually representing a media channel; obtaining session data descriptive of a plurality of user sessions, the plurality of user sessions respectively may include an interaction with an input element rendered at a user device and a request for a resource associated with the input element; generating, by the computing system, utilizing the session data, incrementalities of the media channels; generating, by the computing system, calibrated multi-touch attribution (MTA) results by, for individual ones of the calibrated MTA results: executing computations with a time to event data driven attribution (TEDDA) result, and with a corresponding incrementality of a corresponding test channel; and identifying a result of the computations as the corresponding calibrated MTA result. The instructions also includes modifying, by the computing system, fields of a data structure representing sets of channel characteristics, individual ones of the channel characteristics being associated with the corresponding calibrated MTA result within a non-testing period and being utilized to populate a user interface with one or more selected input elements.

In some embodiments of the one or more non-transitory computer readable media, a first geo with which a non-testing MTA result utilized to generate the calibrated MTA results is associated may include a first city and a second geo with which a fully calibrated result utilized to generate the calibrated MTA results is associated may include a second city, and the first city and the second city are associated with a similarity metric that is less than a threshold.

In some embodiments of the one or more non-transitory computer readable media, the corresponding incrementality of the corresponding test channel may include a percentage of a time to event data driven attribution (TEDDA) result that is predicted to be applicable to the corresponding test channel.

In some embodiments of the one or more non-transitory computer readable media, generating the calibrated MTA results is performed within a threshold time from previously generating prior calibrated MTA results.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an environment for fine-tuned MTA-based experiments using small-scale geos according to example embodiments of the present disclosure;

FIG. 2 depicts an example block diagram depicting channel-based experimentation for geos according to example embodiments of the present disclosure;

FIG. 3 depicts an example chart depicting channel-based experimentation results for geos according to example embodiments of the present disclosure;

FIG. 4 depicts an example chart depicting calibrated MTA results according to example embodiments of the present disclosure;

FIGS. 5-8 depict flowcharts of example methods according to example embodiments of the present disclosure; and

FIG. 9 is a block diagram of an example system for performing fine-tuned MTA-based experiments using small-scale geos according to example embodiments of the present disclosure.

### DETAILED DESCRIPTION

Generally, the present disclosure is directed to generating and utilizing small-scale geos (or “geographies”) and user level data-driven weight-oriented test results with calibration of data analysis model results. The data analysis model results can be generated and calibrated with weight-oriented tests using touchpoints in datasets with the user level data which corresponds to the small-scale geos. Currently, correlation data analysis model results-based estimates reveal correlation but not causality between server-driven operations and operations performed by computing devices of users. Further, currently, tests being performed estimate weights of channels across which server-driven operations at course and inexact levels occur by comparing datasets at country-wide scales. The present disclosure provides for improved systems and methods to allow for experiments performed at small-scale geos, and with user level data, to get more accurate with respect to granularity of test results, and channels utilized to generate the test results. The small-scale and finely turned experiments can be utilized to calibrate data analysis model results to be more accurate than initial data analysis model results as generated.

While techniques according to conventional technology include utilizing data analysis models that estimate correlation between dataset touchpoints and operations performed by computing devices of users, such data analysis models may be unreliable and misleading. For instance, data analysis models assign credit to touchpoints within observed computing-device operation paths, enabling a comparative view of media channel performance. However, data analysis models in general rely on correlational data to assign credit. That is, data analysis model results may not be reflective of true causal impacts of media channels.

Further, techniques according to conventional technology include utilizing large-scale experiments that provide weights associated with server-driven operations associated with different channels with which operations performed by computing devices of users are associated. However, such experiments may be difficult to perform and may produce results that are inaccurate and inexact. For instance, experimentation enables validation of credit allocation generated by data analysis models and results of possible scenarios that may occur without specific marketing interventions, should the parameters in the experiments be instituted in the real world. Incrementality, which includes impacts directly caused by scenarios by which the parameters are applied, may be limited in scope and may not reveal relatively subtle changes associated with server-driven operations in channels that have isolated or narrow impacts.

The present disclosure provides solutions to these problems by generating data representing results of small-scale geo tests, calibrating the results, and scaling different results associated with other regions, and channels within those regions, accordingly. This approach combines small-scale geo tests used to find the weights associated with geos, with results from weight-oriented tests used to calibrate data analysis results within a non-testing period. More particularly, the present disclosure provides for generation of data associated with experiments run in multiple geos, including a control geo and a test geo, and identifying predicted amounts by which the weight-oriented estimates are applicable to data analysis model results, including time to event data results of data analysis models. Thus, calibrated data analysis report results that are associated with various small-scale regions, and generated using weight-oriented experiments with initial data analysis data, include accurate, tailored, and granular information.

Improvements are achieved through small-scale geo tests enabling media channel-oriented weights to be determined and utilized to calibrate the TEDDA results. Experiments are run by activating a media channel (or set of channels) in control markets in which no changes are made for purposes of the experiments. The experiments include turning off the media channel in test markets, while all other channel-oriented operations remain the same. This enables operations performed by computing devices of users that would have been generated in the absence of the channel to be isolated. The operations performed by computing devices of users being isolated include computing device operations that are directly caused by the channel. The testing framework can be applied to different media channel combinations with the results from each geo test serving as pieces of a puzzle. When combining the results from the geo tests, results yielding a comprehensive picture of each media channel's true incremental performance are generated and used to calibrate data analysis model results.

As provided by the present disclosure, the improvements being achieved include small-scale geos to be used for experiments to determine channel-oriented weights without compromising accuracy. data analysis data with user level path data is leveraged for performing experiments that are more accurate due to the level path data being more granular. In contrast to existing systems that utilize whole country level data, experiments performed with more granular data according to the techniques discussed herein enable more information to be generated from the experiments performed at the small-scale geos. Higher levels of confidence in data analysis results enable accurate and precise information to be gathered regarding, if changes are made, whether desired results will be achieved.

The improvements associated with the systems and methods discussed herein can be further understood with reference to the figures. Reference now is made to the figures, which provide example arrangements of computing systems, model structures, and data flows for illustration purposes only.

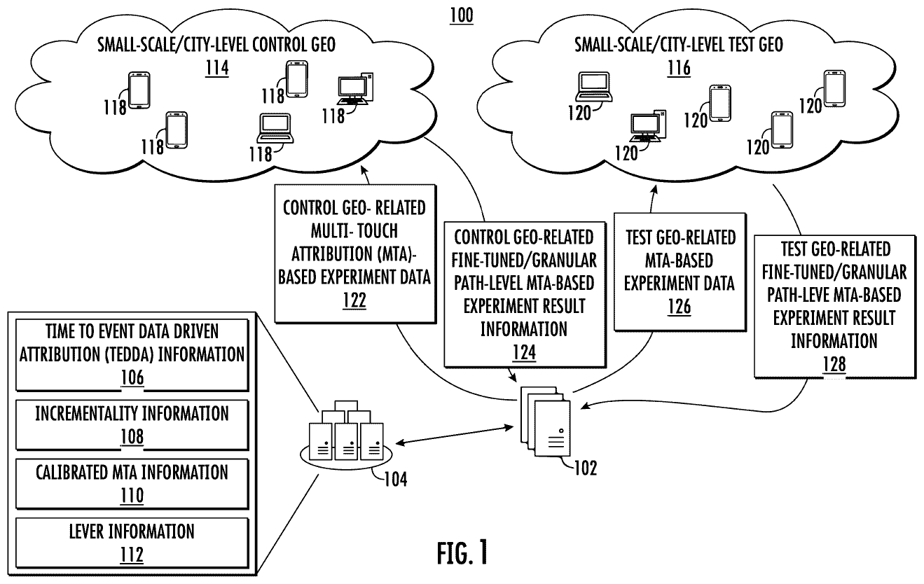

FIG. 1 depicts an environment 100 for granular level MTA-based experiments using small-scale geos according to example embodiments of the present disclosure. The environment 100 can include one or more servers 102 utilized to generate calibrated data analysis results data (e.g., MTA results data). In some examples, the server(s) 102 may be associated with service providers utilized to provide media content of various types. In some examples, the environment 100 can include one or more data centers, such as a data center 104, communicatively coupled to the server(s) 102. The data center 104 can be utilized to manage various types of data managed utilizing data analysis models and weight-oriented experiments (e.g., MTA model and incrementality-oriented experiments). The data managed by the data center 104 can include time-event information (e.g., time to event data driven attribution (TEDDA) information) 106, incrementality information (or “weight information”) 108, calibrated data analysis information (e.g., calibrated MTA information) 110, lever information 112, one or more other types of data of various types, or any combination thereof.

The TEDDA information 106 can be utilized by the server(s) 102 that apply various types of data analysis models (e.g., MTA models) to generate the TEDDA information 106. In some examples, various types of MTA model results can be generated via one or more MTA models. The MTA model(s) can be utilized to determine one or more MTA model results, such as one or more TEDDA results in the TEDDA information 106. For instance, the TEDDA information 106 can be generated utilizing the MTA model(s), such as TEDDA. The MTA model(s) can be applied to data (or “input data”) that is input into the MTA model(s). The input data can include data (or “correlational data”) associated with one or more media channels (also simply referred to herein as “channels”), and/or with media content in the media channel(s).

The TEDDA result(s) in the TEDDA information 106 can include, and/or be identified as, the MTA result(s), which can be, and/or include, one or more MTA credits. For instance, a TEDDA result can include, and/or be identified as, an MTA result, which can be, and/or include, an MTA credit. In such an instance or another instance, the MTA credit can be generated based on, and/or be associated with, a channel from among the media channel(s). In such an instance or another instance, the MTA credit can be generated based on, and/or be associated with, a combination of channels from among one or more combinations of the media channel(s). Individual ones of the TEDDA result(s) may be associated with a geo, such as a control geo from among the control geo(s), as discussed below in further detail.

The incrementality information 108 can include various types of incrementalities, such as marginal incrementalities, overall incrementalities, total incrementalities, other types of incrementalities, or any combination thereof, associated with various types of media channels. In some examples, one or more incrementalities (or “incrementality value(s)”) can be identified by one or more experiments executed utilizing the input data. For instance, the incrementality(ies) can include a marginal incrementality, an overall incrementality, a total incrementality, another type of incrementality, or any combination thereof, associated with an MTA credit, and/or with a media channel of interest that is identified from among the media channel(s). In such an instance or another instance, the incrementality can be associated with the MTA credit, and/or with a combination of media channels of interest from among the combination(s) of the media channel(s). Individual ones of the incrementality(s) may be associated with a geo, such as a test geo from among the test geo(s), as discussed below in further detail.

The calibrated MTA information 110 can be identified based on the MTA model result(s) being calibrated using the incrementality(ies). The MTA model result(s) being calibrated can be output as one or more calibrated MTA results in the calibrated MTA information 110. Individual ones of the calibrated MTA result(s) can include a calibrated MTA result generated with a TEDDA result from among the TEDDA information 106 and an incrementality from among the incrementality information 108. Individual ones of the calibrated MTA result(s) may be associated with a geo, such as a test geo from among the test geo(s), as discussed below in further detail.

The lever information 112 can include various types of calibration levers (also simply referred to herein as “lever”) utilized to generated one or more other calibrated MTA model results (or “other result(s)”) (e.g., from among the calibrated MTA result(s)). The other calibrated result(s) may be associated with one or more other geos and within one or more non-testing periods. For instance, individual ones of the levers can be utilized to generate a calibrated MTA model result from among the other calibrated MTA model result(s) associated with a geo from among the other geo(s) and within a non-testing period from among the non-testing period(s). Individual ones of the lever(s) may be associated with a geo, such as the test geo or another geo (e.g., a non-testing geo). Individual ones of the other result(s) may be generated utilizing a lever from among the lever(s) in the lever information 112.

In some examples, individual ones of the calibration levers can be generated based on various types of information. For instance, information utilized to generate a calibration lever can include a level of similarity between a control destination comprising corresponding first data analysis model credits and a test destination comprising corresponding second data analysis model credits. Alternatively or additionally, information utilized to generate a calibration lever can include a degree of resemblance between the test destination used to establish the corresponding calibration lever and a non-testing destination requiring calibration. Alternatively or additionally, information utilized to generate a calibration lever can include a level of freshness of the calibrated data analysis model results. Alternatively or additionally, information utilized to generate a calibration lever can include a predicted probability of future calibrated data analysis model results being different. In some cases, individual ones of the calibration levers reflect, as a corresponding incrementality of a corresponding test channel, a percentage of TEDDA result that is predicted to be applicable to the corresponding test channel. In some cases, individual ones of the calibration levers reflect a predicted probability of future MTA calibrations being different due to market trends.

In various examples, one or more tests with one or more small-scale geos can be utilized to generate the calibrated MTA result(s). By utilizing the small-scale geo test(s), individual ones of the incrementality(ies) in the incrementality information 108 can include an incrementality estimate. In some cases, the incrementality estimate(s) may be applicable (e.g., directly applicable) to one or more other regions and/or one or more channels within those other region(s). In alternative cases, the incrementality estimate(s) may be applicable (e.g., indirectly applicable) to the other region(s) and/or the channel(s) within the other region(s) by utilizing the calibration lever(s) from among the lever information 112. For instance, with an incrementality estimate being applicable to another region and/or another channel within the other region by utilizing the calibration lever, the TEDDA result, the incrementality estimate, and the lever can be utilized to generate the calibrated MTA result for the other region and/or the channel within the other region.

The environment 100 can include a small scale/city-level control geo (also referred to herein simply as “control geo”) 114 and a small-scale/city-level test geo (also referred to herein simply as “test geo”) 116. The control geo 114 can include one or more computing devices 118. The test geo 116 can include one or more computing devices 120.

The server(s) 102 can exchange various types of communications with the computing device(s) 118 in the control geo 114. In some examples, the communications can include one or more communications utilized to exchange data and/or information, which can include control geo-related MTA-based experiment data (also referred to herein simply as “experiment data”) 122, control geo-related fine-tuned/granular path-level MTA-based experiment result information (also referred to herein as “result information”) 124, one or more other types of data and/or information, and/or any combination thereof.

The experiment data 122 can include various types of data utilized to identify the incrementality information 108 and/or the calibrated MTA information 110. In some examples, one or more portions of the experiment data 122 utilized to identify the incrementality information 108 and/or the calibrated MTA information 110 may be associated with one or more media channels. In those or other examples, individual ones of the portion(s) of the experiment data 122 may be associated with a group of one or more touchpoints (e.g., one or more first touchpoints, one or more second touchpoints, one or more third touchpoints, etc.). Individual ones of the group(s) of touchpoints may be associated with a corresponding channel from among the media channel(s). Individual ones of the group(s) of touchpoints may be associated with spending (e.g., server-driven operations), which may be associated with the corresponding channel.

For instance, a first group of the first touchpoint(s) may be associated with a first channel (or “first control channel”) and with at least one of the computing device(s) 118 in a first geo (or “control geo”). In such an instance or another instance, a second group of the second touchpoint(s) may be associated with a second channel (or “second control channel”) and with at least one of the computing device(s) 118 in the control geo.

The experiment data 122 can include various types of data utilized to provide media content associated with the channel(s) and/or with the touchpoint(s). In some examples, the media content can be provided, via the experiment data 122, by the server(s) 102 and to the computing device(s) 118.

The result information 124 can include various types of information based on the experiment data 122. The result information 124 can include information generated by the computing device(s) 118 that performs one or more operations. Individual ones of the operations(s) may include, occur as, and/or be associated with, a conversion (e.g., an operation performed by a computing device of a user 230, 232, etc.), and/or with an action (e.g., an action performed by a user from among one or more users individually associated with any of the computing device(s) 118). In various instances, the action is of a type that includes, occurs as, and/or is associated with, a conversion. Individual ones of the action(s) include a click, a touch, a keystroke, etc., any other type of action, associated with any portion of computing device (e.g., any of the computing device(s) 118/120), any interface therein, any display, etc.; and/or any image (e.g., portion of an image) output thereby. In some examples, the result information 124 can be provided by the computing device(s) 118 and to the server(s) 102.

The result information 124 can be utilized along with, and/or in combination with, the TEDDA information 106, such as the MTA credit(s), to generate the incrementality information 108. For instance, the incrementality information 108, which can include individual ones of the incrementality(ies) associated with a specific media channel (e.g., a channel C) and a specific geo (e.g., the control geo), can be generated based on an MTA credit associated with the specific media channel and the control geo. In such an instance or another instance, the corresponding incrementality can be generated further based on one or more other MTA credits associated with one or more other corresponding channels (e.g., channels A and B) and with the control geo. In such an instance or another instance, the corresponding incrementality may correspond to, and/or represent an impact of, the specific media channel in driving a specific conversion.

The result information 124 can be utilized along with, and/or in combination with, the TEDDA information 106 (e.g., the MTA credit(s)) and the incrementality information 108 to generate the calibrated MTA information 110. For instance, the calibrated MTA information 110, which can include individual ones of the calibrated MTA results associated with a specific media channel (e.g., a channel C) and a specific geo (e.g., the control geo), can be generated based on an MTA credit associated with the specific media channel and the control geo. In such an instance or another instance, the corresponding calibrated MTA result can be generated further based on one or more other MTA credits associated with one or more other corresponding channels (e.g., channels A and B) and with the control geo. In such an instance or another instance, the calibrated MTA information 110 can be generated further based on a corresponding incrementality associated with the specific media channel and the control geo.

The server(s) 102 can exchange various types of communications with the computing device(s) 120 in the test geo 116. In some examples, the communications can include one or more communications utilized to exchange data and/or information, which can include test geo-related MTA-based experiment data (also referred to herein simply as “experiment data”) 126, test geo-related fine-tuned/granular path-level MTA-based experiment result information (also referred to herein as “result information”) 128, one or more other types of data and/or information, and/or any combination thereof.

Various types of data and/or information exchanged between the server(s) 102 and the test geo 116 can be similar to, or different from, the data and/or information exchanged between the server(s) 102 and the control geo 114. In some examples, the experiment data 126 can be managed (e.g., identified, determined, generated, etc.) in a similar way as the experiment data 122, except based on the test geo (e.g., and the channels associated therewith) instead of the control geo. In those or other examples, the result information 128 can be managed (e.g., identified, determined, generated, etc.) in a similar way as the result information 124, except based on the test geo (e.g., and the channels associated therewith) instead of the control geo.

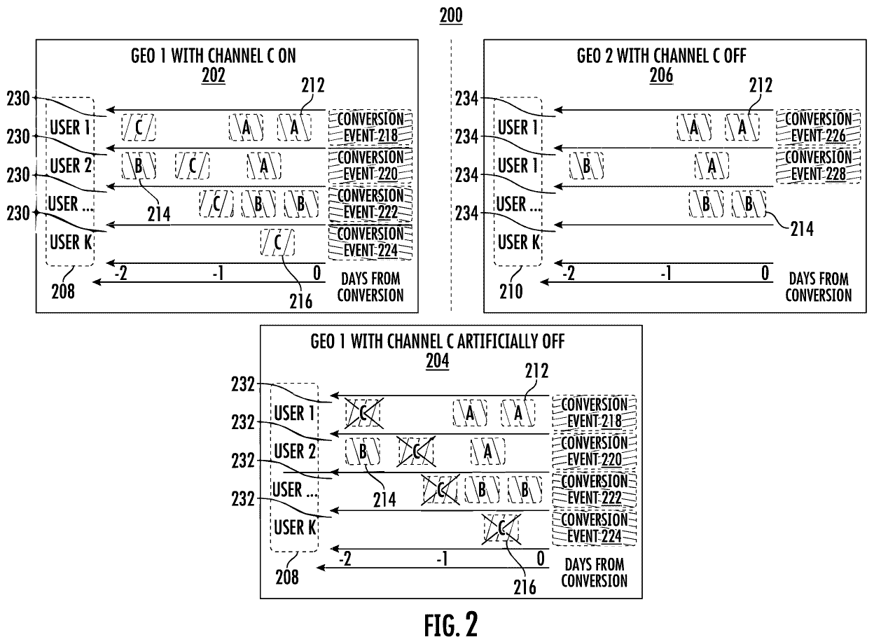

FIG. 2 depicts an example block diagram 200 depicting channel-based experimentation for geos according to example embodiments of the present disclosure. The channel-based experimentation can include exchanging one or more communications between computing devices. The computing devices can include one or more servers (e.g., the server(s) 102, as discussed above with reference to FIG. 1), one or more computing devices (e.g., the computing device(s) 118/120, as discussed above with reference to FIG. 1) of various types, one or more other devices, or any combination thereof.

Various servers and/or computing devices can perform various operations associated with various tests (e.g., geo experiments) utilized to present content (e.g., media content) to various users. The content being presented can be associated with various channels. The tests can include one or more tests managed by the server(s) 102 and utilized to identify various types of information (e.g., characteristics associated with channels, users, and/or computing devices). The characteristics can include one or more characteristics identified based on a test from among the tests(s) (e.g., a test, as depicted in the block diagram 200). The test can be performed utilizing the server(s) 102, and/or input received from one or more users and to the computing device(s) 118 and/or 120.

The test can include one or more operations performed by the server(s) 102 and/or the computing device(s) 118/120, in accordance with one or more stages of the test. In some examples, the test can include, in a first stage 202, one or more operations being performed by the server(s) 102, the operation(s) being associated with a control geo (e.g., the control geo 114, as discussed above with reference to FIG. 1). In those or other examples, the test can include, in a second stage 204, one or more operations being performed by the server(s) 102, the operation(s) associated with the control geo (e.g., the control geo 114). The second stage 204 may be associated with the same geo as in the first stage 202, but with one or more different parameters (e.g., one or more different channel-oriented parameters) than in the first stage 202. In those or other examples, the test can include, in a third stage 206, one or more operations being performed by the server(s) 102, the operation(s) associated with a test geo (e.g., the test geo 116, as discussed above with reference to FIG. 1).

Various stages of the test, and/or communications therein, may be associated with channels (e.g., media channels) of various types. The channels can include, and/or be associated with, one or more channels (e.g., a first channel) (e.g., a channel A) 212 of a first type. The channels can include, and/or be associated with, one or more channels (e.g., a second channel) (e.g., a channel B) 214 of a second type. The channels can include, and/or be associated with, one or more channels (e.g., a third channel) (e.g., a channel C) 216 of a third type. The channel(s) can include, and/or be associated with, one or more other channels of various types.

In some examples, the test can include, as the first stage 202, one or more operations being performed by the server(s) 102, the operation(s) associated with the channels 212-216 (e.g., the channels A, B, and C) (e.g., all of the channels) being turned on. In some examples, the test can include, as the second stage 204, one or more operations being performed by the server(s) 102, the operation(s) associated with the channels 212-216 (e.g., the channels A, B, and C) (e.g., all of the channels) being turned on, except with the channel C 216 being artificially turned off. In such an example or another example, test can include, as the third stage 206, one or more operations being performed by the server(s) 102, the operation(s) for the third stage being associated with the channels 212 and 214 (e.g., the channels A and B) (e.g., less than all of the channels) being turned on. The test in the third stage 206 can include the channel C being turned off.

Various computing devices may be associated with the test in the various stages. In some examples, one or more computing devices (e.g., the computing device(s) 118, as discussed above with reference to FIG. 1) may be associated with the first stage 202 and/or the second stage 204. In those or other examples, one or more computing devices (e.g., the computing device(s) 120, as discussed above with reference to FIG. 1) may be associated with the third stage 206.

The information identified as part of the test, and/or based on the operations and/or stages of the test, can include various types of information. For instance, the information identified as part of the test, and/or based on the operations and/or stages of the test, can include conversion information, incrementality information (e.g., the incrementality information 108, as discussed above with reference to FIG. 1), calibrated MTA information (e.g., the calibrated MTA information 110, as discussed above with reference to FIG. 1), lever information (e.g., the lever information 112, as discussed above with reference to FIG. 1), one or more other types of information, or any combination thereof. The conversion information can include, and/or identify, one or more conversion events (also referred to herein simply as “conversion(s)”) based on the corresponding channels of the individual ones of the stages 202-206 of the test.

The conversion information may be generated based on various types of conversions in the first stage 202. For example, one or more conversions in the first stage 202 may include a conversion 218 associated with a user (e.g., a first user) (or “user 1”) from among the user(s) 208. In such an example or another example, the conversion(s) in the first stage 202 may include a conversion 220 associated with a user (e.g., a second user) (or “user 2”) from among the user(s) 208. In such an example or another example, the conversion(s) in the first stage 202 may include a conversion 222 associated with a user (e.g., a third user) (or “user X”) from among remaining users of the user(s) 208. In such an example or another example, the conversion(s) in the first stage 202 may include a conversion 224 associated with a user (e.g., a fourth user) (or “user K”), such as a last user of the user(s) 208.

The conversion information may be generated based on similar conversions, and/or similar types of conversions, in the second stage 204 as in the first stage 202. For example, the conversions in the second stage 204 may include the conversions 218-224.

The computing device(s) 118, with which individual ones of the conversions 218-224 being identified in the first stage 202 and/or the second stage 204 are associated, may receive the communication(s) associated with the first stage 202 and/or the second stage 204. The computing device(s) 118, with which individual ones of the user(s) 208 are associated, may receive the communication(s) associated with the channels 212-216, in the first stage 202 and/or the second stage 204.

The conversion information may be generated based on different conversions, different types of conversions, and/or different numbers of conversions, in the third stage 206 than in the first stage 202 and/or the second stage 204. For example, the conversions in the third stage 206 may include conversions 226 and 228. As discussed in further detail below, the third stage 206 including the conversions 226 and 228, but not one or more other conversions associated with one or more other users, may be utilized to identify the channel 216 (e.g., the channel C) as being incremental.

The computing device(s) 120, with which individual ones of the conversions 226 and 228 being identified in the third stage 206 are associated, may receive the communication(s) associated with the third stage 206. The computing device(s) 120, with which individual ones of the user(s) 210 are associated, may receive the communication(s) associated with the channels 212 and 214, in the third stage 206.

In some examples, the information identified via the test in the first stage 202, with the channels 212-216 (e.g., channels A, B, and C) turned on, can include one or more incrementalities (e.g., in the incrementality information 108) associated with the first stage 202 and the control geo 114. In those or other examples, the information identified via the test in the second stage 204 can include one or more incrementalities (e.g., in the incrementality information 108) associated with the second stage 204 and the control geo 114. In those or other examples, the information identified via the test in the third stage 206 can include one or more incrementalities (e.g., in the incrementality information 108) associated with the third stage 206 and the test geo 116.

Various types of incrementalities can be identified, such as by utilizing the test in the first-third stages 202-206. The types of incrementalities can include marginal incrementality (M(i)), overall incrementality (I(x)), total incrementality (I(A)+I(B)+I(C)), one or more other types of incrementalities, or any combination thereof.

In some examples, the marginal incrementality can include a marginal incrementality (M(i)) where i=A (e.g., the channel 212) (e.g., the channel A), i=B (e.g., the channel 214) (e.g., the channel B), i=C (e.g., the channel 216) (e.g., the channel C), i=any other channel. In some examples, the marginal incrementality (M(i)) can include a marginal incrementality (M(i)) where i=any channel combination, such as {A, B, C, A∩B, A∩C, . . . , etc.}.

In some examples, the overall incrementality can be include an overall incrementality (I(x)) where x=a channel; or where x=a channel combination. For instance, for channels 212-216 (e.g., channel A-C), the overall incrementalities I(A), I(B), and I(C) can be determined according to the equations, as follows:

$$I ( A ) = M ( A ) + {M}_{A} ( A ⋂ B ) + {M}_{A} ( A ⋂ C ) + {M}_{A} ( A ⋂ B ⋂ C ) \qquad ( 1 )$$

$$I ( B ) = M ( B ) + {M}_{B} ( A ⋂ B ) + {M}_{B} ( B ⋂ C ) + {M}_{B} ( A ⋂ B ⋂ C ) \qquad ( 2 )$$

$$I ( C ) = M ( C ) + {M}_{C} ( A ⋂ C ) + {M}_{C} ( B ⋂ C ) + {M}_{C} ( A ⋂ B ⋂ C ) \qquad ( 3 )$$

where Mx(i) is a contribution of channel x when i is an intersection of a set of channels including x.

By utilizing the equations (1)-(3) to calculate the overall incrementality (I(x)), double counting may be avoided by proportionately allocating the interaction components by their main effects. For example, the marginal incrementality (M(A∩B)) can be calculated according to the equations, as follows:

$$M ( A ⋂ B ) = {M}_{A} ( A ⋂ B ) + {M}_{B} ( A ⋂ B ) \qquad ( 4 )$$

$$where :$$

$${M}_{A} ( A ⋂ B ) = M ( A ⋂ B ) \times M ( A ) / ( M ( A ) + M ( B ) \qquad ( 5 )$$

$${M}_{B} ( A ⋂ B ) = M ( A ⋂ B ) \times M ( B ) / ( M ( A ) + M ( B ) . \qquad ( 6 )$$

Various paths (e.g., converting paths) may be associated with various users. In some examples, individual ones of one or more converting paths 230 may be associated with a corresponding user from among the users 208. The converting path(s) 230 may be associated with the first stage 202 of the test. For instance, a converting path 230 may include two channel A touchpoints and a channel C touchpoint associated with the user 1 of the users 208. The converting path 230 associated with the user 1 may include the conversion 218.

In those or other examples, individual ones of one or more converting paths 232 may be associated with a corresponding user from among the users 208. The converting path(s) 232 may be associated with the second stage 204 of the test. For instance, a converting path 232 may include two channel A touchpoints associated with the user 1 of the users 208. The converting path 232 associated with the user 1 may include the conversion 218.

In those or other examples, individual ones of one or more converting paths 234 may be associated with a corresponding user from among the users 210. The converting path(s) 234 may be associated with the third stage 206 of the test. For instance, a converting path 234 may include two channel A touchpoints associated with the user 1 of the users 208. The converting path 234 associated with the user 1 may include the conversion 226.

As a hypothetical example, a paid media shutdown test (e.g., the test performed as discussed above with reference to FIGS. 1 and 2) maybe performed in a certain market. Results of the test (e.g., to determine incrementality) may be determined and utilized to estimate, for instance, that paid media was responsible for a 10% lift in acquisition conversions. However, preliminary values for the MTA (e.g., initial MTA) may have indicated that paid media was assigned credit for 15% of all conversions. The incrementality number of 10% may, therefore, be utilized to proportionally scale back the assigned credit from the MTA (e.g., the initial MTA). Additional incrementality data points may also be determined on particular channels or combinations of channels to generate date points. The generated data points may be utilized to calibrate the MTA result at the channel level. While acquiring incrementality data points on paid media may be time-consuming and expensive according to existing technology that performs whole country geo tests, the tests performed according to the techniques discussed herein, such as smaller geo tests (e.g., such as at the city level) may be utilized in combination with MTA (e.g., and user level data) to obtain incrementality data points at less expense and a faster cadence.

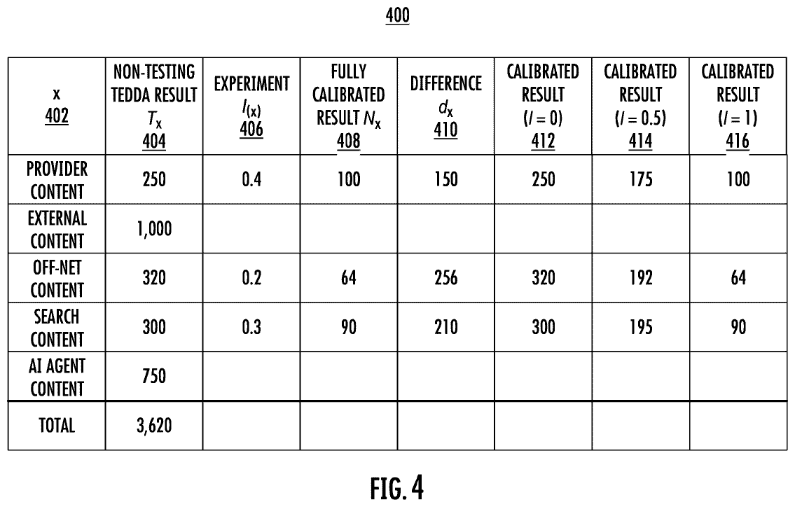

In the hypothetical, the incrementality data points may be utilized along with levers (e.g., the lever 1, as discussed below with reference to FIG. 4) to identify calibrated MTA results (e.g., the results 412-416, as discussed below with reference to FIG. 4), associated with the test geo and/or any number of other geos. Test results may enable automation of exposures (e.g., spending) across all markets (e.g., 188 countries). Changes may be easily made in all countries. In some examples, optimal reallocation of the latest sets of results (e.g., the calibrated MTA results) may be performed at any rate (e.g., every quarter, every mid-quarter, every week, etc.). The reallocations can be utilized as course-corrections to optimize exposures based on conversions, incrementality, levers, etc. Calibration can be performed, and calibrated MTA result-based decisions can be made, using calibrated MTA results at small scales (e.g., for small-scale geos). The relatively faster cadence for generating the calibrated MTA results may be achieved because of the usage of the small-scale geos.

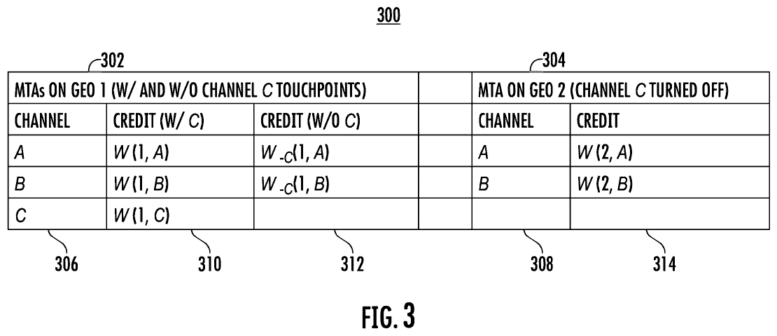

FIG. 3 depicts an example chart 300 depicting channel-based experimentation results for geos according to example embodiments of the present disclosure. The chart 300 can include MTAs on geo 1 (with and without channel C touchpoints) 302 and MTAs on geo 1 (channel C turned off) 304.

The chart 300 can include channels 306, which can include various channels utilized for a test (e.g., the test performed by the server(s) 102, as discussed above with reference to FIGS. 1 and 2). The channels 306 can include channels A, B, and C (e.g., the channels 212, 214, and 216, respectively, as discussed above with reference to FIG. 2). In some examples, the channels 306 can be utilized for one or more stages of the test, such as a first stage and a second stage (e.g., the first stage 202 and the second stage 204, respectively, as discussed above with reference to FIG. 2).

The chart 300 can include channels 308, which can include various channels utilized for the test. The channels 308 can include channels A and B (e.g., the channels 212 and 214, respectively). In some examples, the channels 308 can be utilized for one or more stages of the test, such as a third stage (e.g., the third stage 206, as discussed above with reference to FIG. 2).

The chart 300 can include one or more credits W (with channel C), such as one or more credits W(1,x) (with channel C) 310 associated with the channels 306, with 1 representing the geo 1 (e.g., the control geo 114, as discussed above with reference to FIG. 1). In some examples, the credit(s) W(1,x) (with channel C) 310 can include credit W(1,A) associated with the channel 212 (e.g., the channel A) in the channels 306 (e.g., associated with the control geo 114). In those or other examples, the credit(s) W(1,x) (with channel C) 310 can include credit W(1,B) associated with the channel 214 (e.g., the channel B) in the channels 306 (e.g., associated with the control geo 114). In those or other examples, the credit(s) W(1,x) (with channel C) 310 can include credit W(1,C) associated with the channel 216 (e.g., the channel C) in the channels 306 (e.g., associated with the control geo 114).

The credit(s) W (without channel C touchpoints) can include credit W(1,x) (without channel C) 312 associated with the channels 306, with 1 representing the geo 1 (e.g., the control geo 114). In some examples, the credit(s) W−C(1,x) (without channel C) 312 can include credit W−C(1,A) 312 associated with the channel 212 (e.g., the channel A). In those or other examples, the credit(s) W(1,x) (without channel C) 312 can include credit W−C(1,B) 312 associated with the channel 214 (e.g., the channel B).

The chart 300 can include one or more credits W (with channel C turned off), such as one or more credits W(2,x) (with channel C turned off) 314 associated with the channels 308, with 2 representing the geo 2 (e.g., the test geo 116, as discussed above with reference to FIG. 1). In some examples, the credit(s) W(2,x) (with channel C turned off) 314 can include credit W(2,A) 314 associated with the channel 212 (e.g., the channel A) in the channels 308 (e.g., associated with the test geo 116). In those or other examples, the credit(s) W(2,x) (with channel C turned off) 314 can include credit W(2,B) 314 associated with the channel 214 (e.g., the channel B) in the channels 308 (e.g., associated with the test geo 116).

In some examples, in the control geo 114, when the channel C touchpoints are removed in the second stage 204, there may be some converting paths (e.g., the path 232 that includes the conversion 224) that are left with no other interactions (e.g., conversions). The conversions associated with the path 232 that includes the conversion 224 are identified as 0(1,C). In some examples, based on the channel 216 (e.g., the channel C) being incremental, a prediction may be made that i) W−C(1,A)>W(2,A); and ii) W−C(1,B)>W(2,B).

Marginal incrementalities associated with the channels can be calculated. For instance, a marginal incrementality of the channel 216 (e.g., the channel C) be calculated according to an equation, as follows:

$${M}_{C} = \frac{[ {W}_{- C} ( 1 , A ) - W ( 2 , A ) ] + [ {W}_{- C} ( 1 , B ) - W ( 2 , B ) ] + 0 ( 1 , C )}{W ( 1 , C )} \qquad ( 7 )$$

In various examples, the marginal incrementality of the channel 216 (e.g., the channel C) can be calculated utilizing equation (7) within a threshold error. The marginal incrementality can be calculated utilizing equation (7) within the threshold error because a similarity score between the control geo 114 and the test geo 116 is less than a threshold similarity score.

In some examples, the marginal incrementality of individual ones of the channels 212-216 can be estimated conditional on at least one of the other channels 212-216 (e.g., at least one of the other channels A-C). In alternative examples, the marginal incrementality of individual ones of various combinations of the channels 212-216 can be estimated conditional on all of the other channels 212-216 (e.g., all of the other channels A-C). In various cases, the marginal incrementality of the channel 212 (e.g., the channel A) can be estimated in a similar way as for the marginal incrementality of the channel 216 (e.g., the channel C). In various cases, the marginal incrementality of individual ones of various components (e.g., combinations of the channels 212-216), such as A∩B, A∩C, B∩C, and A∩B∩C, can be estimated in a similar way as for the marginal incrementality of the channel 216 (e.g., the channel C). For instance, with cases in which the marginal incrementality of a component A∩B is estimated, the test is performed by turning off the component in the test geo 116. Then, any pertinent calculations from among, and/or similar to, the marginal incrementality calculations (1)-(7) are performed for A∩B instead of C.

An upper bound on total incrementality of media of a type can be calculated and utilized to calculate marginal incrementality, total incrementality, any other type of incrementality, or any combination thereof. For example, an upper bound on total incrementality of all paid media can be calculated. In such an example or another example, incrementality of all paid media versus no paid media can be calculated by turning off all paid channels in the test geo 116 and running the MTA model in the control geo 114, such as in the third stage 206 (e.g., except with all paid media channels being turned off instead of the channel C 216). In such an example or another example, the MTA model in the control geo 114 with all paid media channels being artificially removed, such as in the second stage 204 (e.g., except with all paid media channels being artificially removed instead of the channel C 216).

By comparing results of the second stage 204 (except with all paid media channels being artificially removed instead of the channel C 216) and the third stage 206 (e.g., except with all paid media channels being turned off instead of the channel C 216), an upper bound of the aggregate total incrementality of all channels (e.g., including the channels 212-216, and, possibly one or more other channels) can be estimated. The upper bound of the aggregate total incrementality of all channels can be used to shrink the total incrementality (I(A)+I(B)+I(C)) towards the upper bound.

In some examples, a test (e.g., a test setup) to find the upper bound is the same as the test to find M(A∩B∩C) except with respect to how the test (e.g., the MTA model) is run for the control geo 114. For instance, with respect to calculating marginal incrementality, the incrementality of a A∩B∩C component may be quantified, by turning off, in the third stage 206, only occurrences of A, B, and C together in paths (e.g., with only occurrences of A, B, and C together in paths being artificially removed in the second stage 204). Alternatively, with respect to calculating total incrementality, the incrementality of all three channel components may be quantified by turning off, in the third stage 206, all occurrences of A, B, and C, either separate or together in paths (e.g., with all occurrences of A, B, and C, either separate or together in paths, being artificially removed in the second stage 204).

FIG. 4 depicts an example chart 400 depicting calibrated MTA results according to example embodiments of the present disclosure. The chart 400 can include various types of information associated with various types of content associated with individual ones of channels 402 (e.g., the channels 306 and 308 associated with the control geo and the test geo, respectively, as discussed above with reference to FIG. 3). In some examples, the content in a channel from among the channels 402 can include provider content. In those or other examples, the content associated with a channel from among the channels 402 can include external content. In those or other examples, the content associated with a channel from among the channels 402 can include off-net content. In those or other examples, the content associated with a channel from among the channels 402 can include search content. In those or other examples, the content associated with a channel from among the channels 402 can include artificial intelligence (AI) agent content.

The chart 400 can include one or more non-testing TEDDA results (or “Tx”) 404. Individual ones of the non-testing TEDDA result(s) Tx 404 may be associated with a channel from among the channels 402. For instance, a non-testing TEDDA result TC 404 with a value of 250 may be associated with the provider content, and/or the corresponding channel 402, such as the channel 216 (e.g., the channel C), that includes the provider content.

The chart 400 can include one or more experiment values (e.g., one or more overall incrementalities) (or “I(x)”), such as I(A), I(B), and I(C) for the channels A, B, and C (e.g., channels 212-216, as discussed above with reference to FIG. 2). In some examples, the overall incrementality(ies) I(x) 406 can be determined using individual ones of the equations (1)-(3), as discussed above with reference to FIG. 2). For instance, an overall incrementality I(C) 406 for the channel 216 (e.g., the channel C) associated with the provider content, and/or the corresponding channel 402 that includes the provider content, may be 0.4 (e.g., 40%).

The chart 400 can include one or more fully calibrated results (or “Nx”) 408. In some examples, individual ones of the fully calibrated result(s) 408 (Nx=[Tx×I(x)]) can be calculated by multiplying the corresponding non-testing TEDDA result Tx 404 by the corresponding overall incrementality I(x) 406. For instance, a fully calibrated result (or “NC”) 408 for the channel 216 (e.g., the channel C) calculated by multiplying the corresponding non-testing TEDDA result TC 404 (e.g., 250) by the corresponding overall incrementality I(C) 406 (0.4) may be 100.

The chart 400 can include one or more differences (or “dx”) 410. In some examples, individual ones of the difference(s) 410 (dx=[Tx×Nx]) can be determined by subtracting the corresponding non-testing TEDDA result Tx 404 by the fully calibrated result Nx 408. For instance, a difference dC 410 for the channel 216 (e.g., the channel C) calculated by subtracting the corresponding non-testing TEDDA result TC 404 (e.g., 250) by the fully calibrated result NC 408 (e.g., 100) may be 150.

The chart 400 can include calibrated results 412, 414, and 416. In some examples, individual ones of the calibrated results 1 412, 414, and 416 can be managed (e.g., identified, determined, generated, modified, etc.) based on the corresponding lever (or “1”). In those or other examples, individual ones of the calibrated results 412, 414, and 416 can be calculated by multiplying the corresponding lever 1 by the corresponding difference dx 410, and subtracting, from the TEDDA result Tx 404, a product of the corresponding lever 1 being multiplied by the corresponding difference dx 410.

In some examples, individual ones of the calibrated results 412, 414, and 416 can be freshly generated. For example, generating the calibrated MTA results may be performed within a threshold time from previously generating prior calibrated MTA results.

The calibrated results 412, 414, and 416, and the corresponding levers 1, may be associated with geos (e.g., different geos), respectively. For instance, a calibrated result 412, and a corresponding lever 1, may be associated with a test geo (e.g., the test geo 116, as discussed above with reference to FIG. 1). In such an instance or another instance, the lever 1 associated with the test geo 116 may have a value of 0. In such an instance or another instance, the calibrated result 412 (x=Tx−[1×dx]) for the channel 216 (e.g., the channel C) and for the test geo 116 can be calculated by multiplying the corresponding lever 1 (e.g., 0) by the corresponding difference dx 410 (e.g., 150), and subtracting, from the TEDDA result Tx 404 (e.g., 250), a product (e.g., 0) of the corresponding lever 1 (e.g., 0) being multiplied by the corresponding difference dx 410 (e.g., 150) to determine the calibrated result 412 for the channel 216 (e.g., the channel C) and for the test geo 116 to be 250.

The calibration lever 1 can include a value between 0 and 1. For example, the lever 1 having a value of 0 may reflect, and/or correspond to, zero confidence that applying the incrementality estimates will yield the calibrated result x 412 as being equal to the fully calibrated result(s) 408 (Nx). In such an example or another example, the lever 1 having a value of 0 may reflect, and/or correspond to, the calibrated result x 412 as being equal to the non-testing TEDDA result Tx 404.

The calibration levers 1 can be used to increase usability of incrementality tests and attribution modelling (e.g., MTA models). In some cases, the calibration levers 1 generated based on control and test geos (e.g., the control geo 114 and the test geo 116) can be used in certain geos (e.g., other geos/markets) without performing incrementality tests for those geos. Although incrementality tests may be valuable, they can be difficult and even impractical to perform in certain geos. This may be due to costs of the incrementality tests and potential interference with other ongoing tests.

Assigning credit to channels through attribution modeling offers a simpler and more readily repeatable approach (e.g., such as by utilizing the calibration levers 1). In some examples, the calibration lever(s) 1 can be utilized to generate the calibrated result(s) x 412/414/416 by comparing control and test geos (e.g., the control geo 114 and the test geo 116) based on certain assumptions. Assumptions being utilized to generate the calibrated result x 412 with the calibration lever(s) 1 can include that geos are similar (e.g., that geos are associated with a similarity metric below a threshold metric). Assumptions being utilized to generate the calibrated result(s) x 412/414/416 with the calibration lever(s) 1 can include that conversion volumes associated with geos are equivalent (e.g., that conversion volumes are associated with a similarity metric below a threshold metric), and that the continuous execution of tests is often not feasible. The calibration lever(s) 1 enable confidence in incrementality test results to be quantified (e.g., as the calibrated results x 412 based on the calibration lever(s) 1). Calibration levers 1 enable the quantified confidence in incrementality test results to be incorporated into the calibration process (e.g., the process including the test utilized to generate the information in the chart 400).

In a hypothetical example, a server 102 can be controlled to run a test, such as small-scale geo experiment using user-level data. The server 102 can run the test by identifying conversions 218-224 based on various channels 212-216 (e.g., channels A, B, and C) in a control geo 114. Various content associated with the channels A-C can be communicated to user devices (e.g., the computing devices 118), as part of the test. The server 102 can identify conversions 218-224 for the control geo 114 based on control channel C being artificially turned off. The server 102 can identify conversions 226 and 228 based on various channels 212 and 214 (e.g., channels A and B) in a test geo 116. Various content associated with the channels A and B can be communicated to user devices (e.g., the user devices 120), as part of the test. Channel C can be turned off for the test geo 116. Conversions in the test geo 116 without channel C may be less than in the control geo 114 in which channel C is artificially turned off.

In the hypothetical example, the number of conversions in the test geo 116 without channel C may be less than in the control geo 114 in which channel Cis artificially turned off due to channel C being incremental. MTA credit for channel A in the control geo 114 with channel C being artificially turned off may be greater than MTA credit for channel A in the test geo 116 in which channel C is off due to channel C being incremental. MTA credit for channel B in the control geo 114 with channel C being artificially turned off may be greater than MTA credit for channel B in the test geo 116 in which channel C is off due to channel C being incremental.

In the hypothetical example, the non-testing TEDDA result for channel C may be 250, with the incrementality of C being 40%. The fully calibrated result associated with channel C in the test geo 116 may be 100. The calibrated result associated with channel C in the test geo 116 may be 250. In another geo, for which a lever of 0.5 is identified, the calibrated result associated with channel C may be 175. In another geo, for which a lever of 1 is identified, the calibrated result associated with channel C may be 100 (e.g., corresponding to a high level of confidence in the incrementality of 40% being accurate with respect to that geo).

In the hypothetical example, notwithstanding any limitations due to privacy measures on long-term storage of location-based data associated with user accounts and administration, utilizing MTA results, incrementality, and levers enables calibrated results to be accurately, efficiently, and affordably obtained. Although difficulties may exist in identifying connections (e.g., relationships) between clicks occurring with a significant time gap (e.g., a click followed by another click (e.g., a second click) a number of days (e.g., 30+) days later beyond a threshold number of days), the most recently observed geolocation within a lookback window (e.g., a loopback window of a number of days meeting or exceeding a threshold number of days) may be applied (e.g., assigned) to all prior interactions within an attribution path and/or for a particular user. By applying the most recently observed geolocation, the clicks (e.g., associated with conversions), and the connections therebetween, may be taken into account and identified as individual ones of the conversions (e.g., the conversions 218-228, one or more other conversions, or any combination thereof).

In the hypothetical example, a most recently observed geolocation within a lookback window (e.g., a loopback window of a number of days meeting or exceeding a threshold number of days) applies to all prior interactions within an attribution path (e.g., a patch outlining interactions based on channels and/or channel touchpoints). For instance, a last known location of a user (e.g., a computing device thereof), becomes representative of a location of a user throughout the earlier stages of a journey of the user).

In the hypothetical example, because a test (e.g., individual ones of the tests, such as geo-based incrementality tests) may not always be feasible, the lever information 112 (e.g., the levers 412-416, etc., one or more other levers, or any combination thereof) may be utilized to apply non-testing TEDDA results and incrementalities to different geos. A test may not be feasible (e.g., associated with a likelihood of success being greater than a threshold likelihood, and/or predicted to have an error in a result of the test that is greater than a threshold error) due to various reasons, such as regional characteristics (e.g., making performance of the tests difficult) and/or outdated calibration data. To compensate for a test that may not be feasible, calibration results may be extrapolated (e.g., as the calibrated results 412, 414, 416, etc., from tested regions (e.g., the test geo 116) and applied them to other geos (e.g., other areas, markets, etc.,) where direct testing may not be feasible. The calibration results may be extrapolated by applying calibration levers (e.g., as discussed above), enabling the extrapolated results to account for inherent differences between a source market (e.g., the control geo 114) and a target market (e.g., other geos).

In the hypothetical example, in contrast to conventional technologies that may have inherent risks that can undermine the accuracy of test results, the test according to the techniques discussed herein that utilizes small-scale geos and user input data enables the accuracy of the test to be relatively greater. The test (e.g., a matched markets experiment with separate test and control regions) utilizes the small-scale geos and the user input data to produce results with relatively greater accuracy than in existing systems. According to the techniques discussed herein, by running smaller scale geo tests at higher frequencies, calibrated MTA model results utilizing levers can be generated with relatively greater statistical variability, enabling any hidden biases to average out. As such, in contrast to conventional technologies, the test according to the techniques discussed herein compensates for potentially otherwise unaccounted—for variables (e.g., variables that may reduce reliably of tests and/or comparisons performed between the test and control markets).

In the hypothetical example, the techniques discussed herein include performing tests to generate calibrated results with levers, utilizing small-scale geos (e.g., cities, counties, neighborhoods, any other type of small-scale geos, or any combination thereof) and user input data, the geos being relatively smaller than large-scale geos (e.g., countries, etc.) used in conventional systems. Due to relatively subtle differences between regions (e.g., demographics, economic factors, etc.), and/or due to differences in channel-oriented calculation results between large-scale geos (e.g., countries) being hidden by other more relatively dominant characteristics, conventional technologies may be inadvertently unable to be utilized to distinguish between data identifying channels that are incremental and data that is affected by hidden biases influencing behavior and that drives different conversion volumes. However, the geo-experiments performed according to the techniques discussed herein that include running smaller scale geo tests at higher frequencies produce results with relative accuracy with respect to identifying whether channels are incremental or not, notwithstanding regions being tested and/or analyzed having subtle differences from one another. The tests performed according to the techniques discussed herein can be performed, utilizing the small-scale geos, at rates that are relatively greater than in existing technologies that are utilized for comparisons with large-scale geos, such as experiments performed with whole countries.

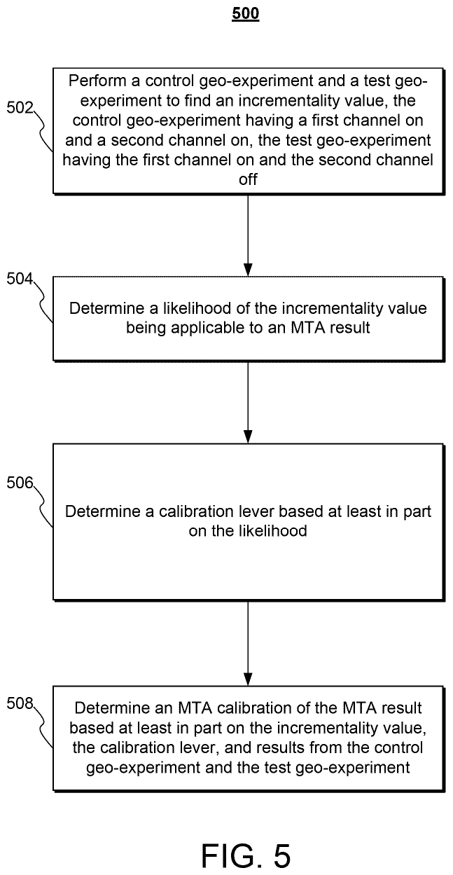

FIGS. 5-8 depict flowcharts of example methods 500, 600, 700, and 800 according to example embodiments of the present disclosure. Although FIGS. 5-8 depict steps performed in particular orders for purposes of illustration and discussion, the methods of the present disclosure are not limited to the particularly illustrated orders or arrangements. The various steps of methods 500-800 can be omitted, rearranged, combined, or adapted in various ways without deviating from the scope of the present disclosure.

With respect to FIG. 5, the method 500 for calibrating MTA results and identifying calibration levers is depicted. At (502), the method 500 can include performing a control geo-experiment and a test geo-experiment to find an incrementality value, the control geo-experiment having a first channel on and a second channel on, the test geo-experiment having the first channel on and the second channel off. The control geo-experiment can be performed for a control geo. The test geo-experiment can be performed for a test geo. In some examples, a single experiment, which may include the control geo-experiment and the test geo-experiment, can be performed.

At (604), the method 600 can include determining a likelihood of the incrementality value being applicable to an MTA result.

At (606), the method 600 can include determining a calibration lever based at least in part on the likelihood.

At (608), the method 600 can include determining an MTA calibration of the MTA result based at least in part on the incrementality value, the calibration lever, and results from the control geo-experiment and the test geo-experiment. In some examples, the the MTA result can include a TEDDA result.

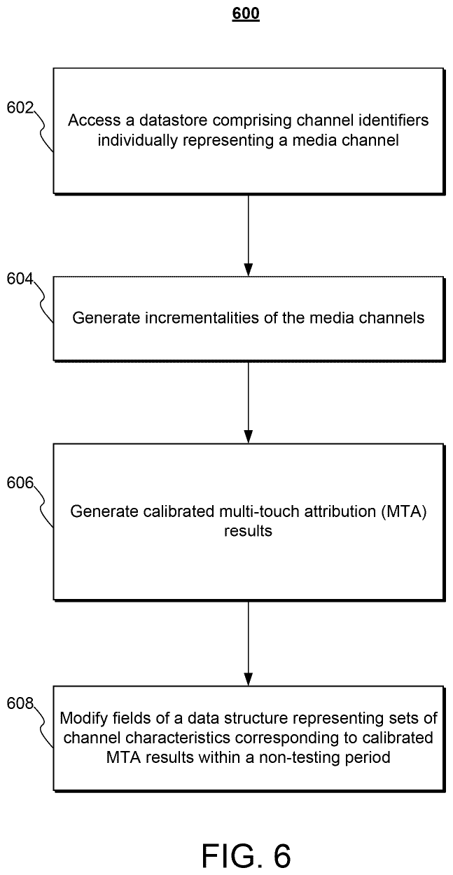

With respect to FIG. 6, the method 600 for calibrating MTA results utilized to modify fields of a data structure is depicted. At (602), the method 600 can include accessing a datastore comprising channel identifiers individually representing a media channel. In some examples, individual ones of the channel identifiers may be utilized to identify the media channel(s), such as channels 212, 214, and/or 216.

At (604), the method 600 can include generating incrementalities of the media channels. The incrementalities (e.g., overall incrementalities 406) can be included in the incrementality information 108. In some examples, the incrementalities can include marginal incrementalities (M(i)), overall incrementalities (I(x)), total incrementalities (I(A)+I(B)+I(C)), individual ones of one or more other types of incrementalities, or any combination thereof.

At (606), the method 600 can include generating calibrated MTA results. In some examples, the calibrated MTA results (e.g., the calibrates results 412-416, individual ones of one or more other types of calibrates MTA results, or any combination thereof) can be generated utilizing non-testing TEDDA result(s) Tx 404, overall incrementality(ies) I(x) 406, fully calibrated result(s) (Nx) 408, difference(s) (dx) 410, individual ones of one or more other types of parameters, or any combination thereof.

At (608), the method 600 can include modifying fields of a data structure representing sets of channel characteristics corresponding to calibrated MTA results within a non-testing period. The fields of the data structure may represent the sets of channel characteristics, individual ones of the characteristics including an identifier and/or flag associated with a server-driven operation. In some examples, the server driven operation(s), for example, can be utilized to control one or more communications between the server(s) 102 and/or the computing devices (e.g., the computing device(s) 118/120, one or more other computing devices in other geos, or any combination thereof). In those or other examples, the server driven operation(s), for example, can be utilized to control one or more operations of the server(s) 102 and/or one or more operations of the computing devices (e.g., the computing device(s) 118/120, one or more other computing devices in other geos, or any combination thereof).

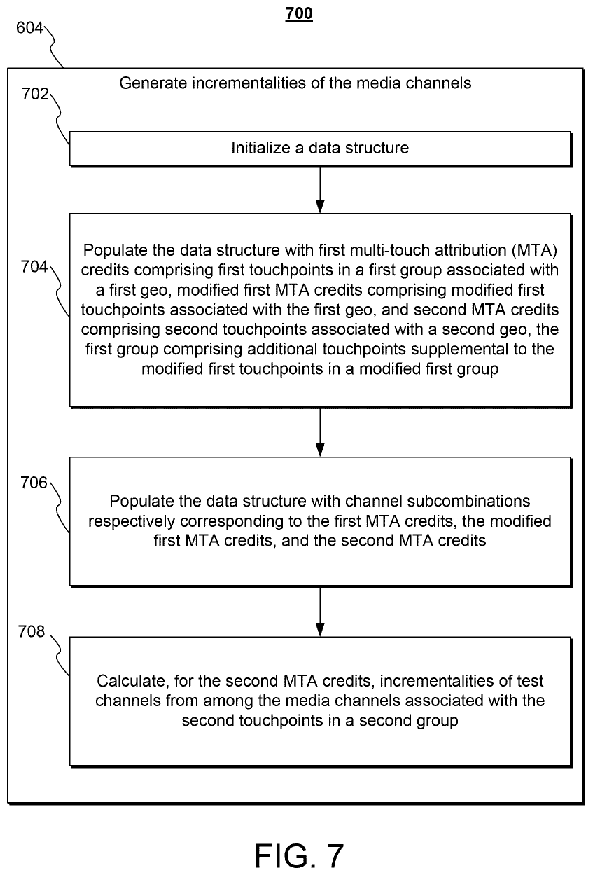

With respect to FIG. 7, the method 700 for generating incrementalities of the media channels is depicted. At (702), the method 700 can include initializing a data structure.

At (704), the method 700 can include populating the data structure with first multi-touch attribution (MTA) credits comprising first touchpoints in a first group associated with a first geo, modified first MTA credits comprising modified first touchpoints associated with the first geo, and second MTA credits comprising second touchpoints associated with a second geo, the first group comprising additional touchpoints supplemental to the modified first touchpoints in a modified first group. In some examples, the modified first touchpoints do not include any touchpoints associated with the channel 216 (e.g., the channel C). In those or other examples, the modified first touchpoints (e.g., associated with the channels 212 and 214) may include fewer touchpoints than the first touchpoints (e.g., associated with the channels 212, 214, and 216).

At (706), method 700 can include populating the data structure with channel subcombinations corresponding to the first MTA credits, the modified first MTA credits, and the second MTA credits. In some examples, a subcombination (e.g., a first subcombination) of channels may be associated with the first MTA credits being generated for the control geo 114. In those or other examples, a subcombination (e.g., a modified first subcombination) of channels may be associated with the modified first MTA credits (e.g., the first MTA credits generated for the control geo 114 based on the channel 216 being artificially off). In those or other examples, a subcombination (e.g., a second subcombination) of channels may be associated with the second MTA credits (e.g., the second MTA credits being generated for the test geo 116 based on the channel 216 being turned off). A combination of channels associated with an individual test may include the subcombinations (e.g., the first subcombination, the modified first subcombination, and the second subcombination).

At (708), the method 700 can include calculating, for the second MTA credits, incrementalities of test channels from among the media channels associated with the second touchpoints in a second group. For example, the incrementalities may include an incrementality calculated for test channel (e.g., the channel 216). The incrementality calculated for the channel 216 (also referred to herein as the “test channel”) may be based on the channels 212 and 214 being turned on, and the channel 216 being turned off, for the test geo 116. The incrementality calculated for the channel 216 may be calculated based on the second MTA credits, which may include the credit W(2,A) 314 the credit W(2,B) 314.

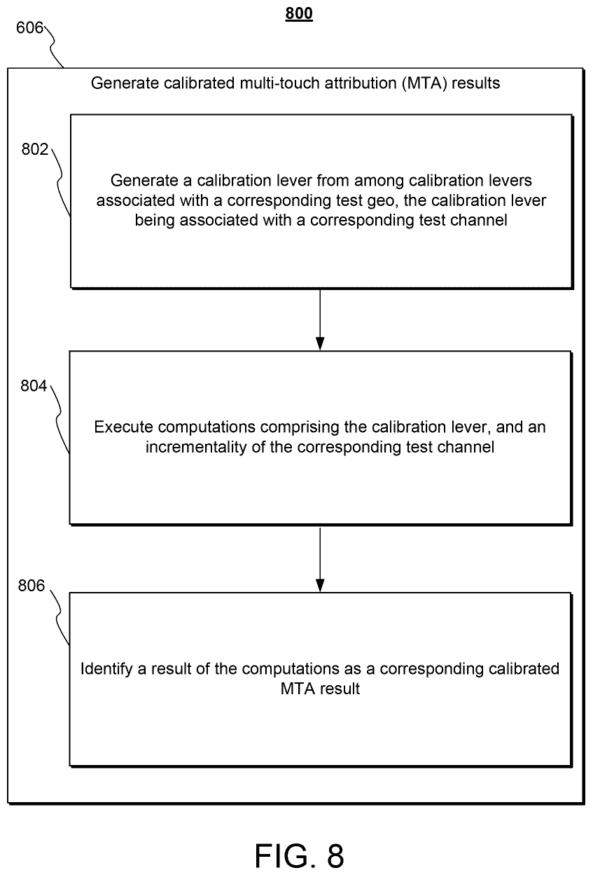

With respect to FIG. 8, the method 800 for generating calibrated MTA results is depicted. At (802), the method 800 can include generating a calibration lever from among calibration levers associated with a corresponding test geo, the calibration lever being associated with a corresponding test channel. In some examples, the calibration lever can include a lever 1 utilized to calculate any of the calibrated results (x) 412, 414, and 416. The lever 1 may be associated with the channel 216.

At (804), the method 800 can include executing computations comprising the calibration lever, and an incrementality of the corresponding test channel. The computations can include any of one or more computations (e.g., utilized to identify any information 310-314, as discussed above with reference to FIG. 3) (e.g., utilized to identify any information 402-416, as discussed above with reference to FIG. 4), and/or one or more other computations. In some examples, the computations can include calculating any of equations (1)-(8). For instance, the computations can include calculating the calibrated results (x) 412, 414, and 416, utilizing the non-testing TEDDA result(s) Tx 404, the overall incrementality(ies) I(x) 406, the fully calibrated result(s) Nx 408, difference dx 410. In such an instance or another instance, the computations can include calculating the calibrated result (C) 412 based on the test geo 116 having the channel 216 turned off, utilizing the non-testing TEDDA result(s) TC 404, the overall incrementality(ies) I(C) 406, the fully calibrated result(s) NC 408, and the difference dC 410.

At (806), the method 800 can include identifying a result of the computations as a corresponding calibrated MTA result. For example, the result can be identified as the calibrated result (C) 412 based on the test geo 116 having the channel 216 turned off.

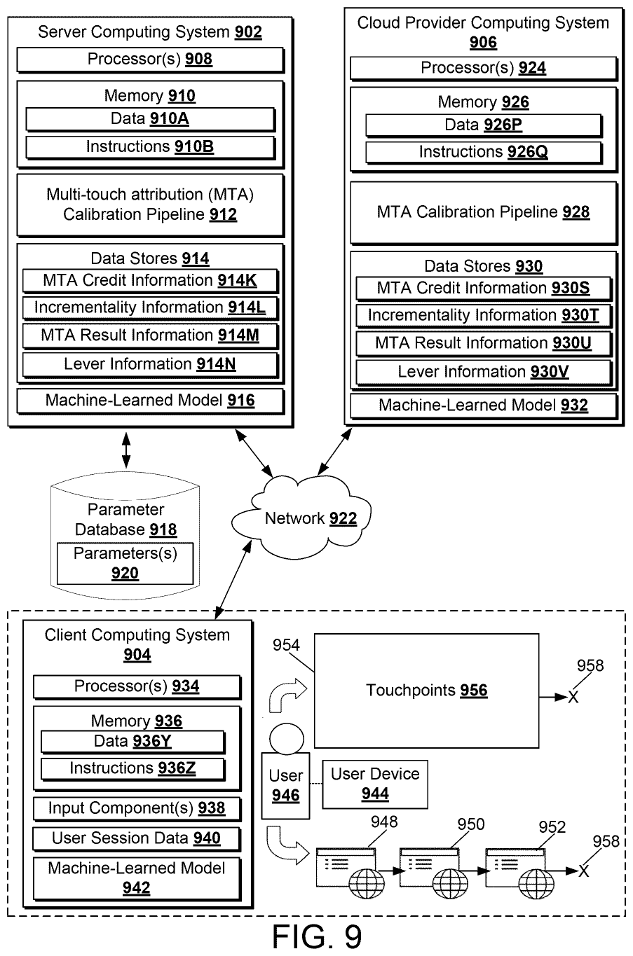

FIG. 9 is a block diagram of an example system 900 for performing fine-tuned MTA-based experiments using small-scale geos according to example embodiments of the present disclosure. The example system 900 can include a server computing system 902, a client computing system 904, and/or a cloud provider computing system 906. In some examples, the server computing system 902 and/or the cloud provider computing system 906 can be utilized, independently or as an integrated system, to implement the server(s) 102, the data center 104, and/or any combination thereof.

The server computing system 902 can include one or more processor(s) 908. The server computing system 902 can include memory 910. The memory 910 can include data 910A and/or instructions 910B. The one or more processors 908 can be any suitable processing device (e.g., a processor core, a microprocessor, an ASIC, an FPGA, a controller, a microcontroller, etc.) and can be one processor or a plurality of processors that are operatively connected. The memory 910 can include one or more non-transitory computer-readable storage media, such as RAM, ROM, EEPROM, EPROM, flash memory devices, magnetic disks, etc., and combinations thereof. The memory 910 can store data 910A and instructions 910B which are executed by the processor 908 to cause the server computing system 902 to perform operations.

The server computing system 902 can include an MTA calibration pipeline 912. The MTA calibration pipeline 912 can be utilized to manage one or more exchanges of information with the server computing system 902. The exchange(s) of information can include any communications (e.g., any of the communication(s) with the data 122 and/or 126, and/or with the information 124 and/or 128, any of one or more other communications, or any combination thereof). For example, exchange(s) of information can include any communications (e.g., one or more secure communications, one or more unsecure communications, etc., or any combination thereof) with any user device (e.g., the user device 944, as discussed below in further detail).

The server computing system 902 can include data stores 914. The data stores 914 can include MTA credit information 914K, incrementality information 914L, MTA result information 914M, and lever information 914N. In some examples, the MTA credit information 914K can include the credit(s) W(1,x) (with channel C) 310, the credit(s) W(2,x) (with channel C turned off) 314, one or more other types of credits, or any combination thereof. In some examples, the incrementality information 914L can include the incrementality information 108, the overall incrementality(ies) I(x) 406, one or more other types of incrementalities, or any combination thereof. In some examples, the MTA result information 914M can include the TEDDA information 106 (e.g., which can include the non-testing TEDDA result(s) Tx 404), the calibrated MTA information 110, the fully calibrated result(s) Nx 408, the calibrated results (x) 412, 414, and 416, one or more other results of various types, or any combination thereof. In some examples, the lever information 914N can include the lever information 112, the levers 1 utilized to calculate the calibrated results (x) 412, 414, and 416, one or more other types of levers, or any combination thereof.

The server computing system 902 can include one or more machine-learned models 916. In some examples, the machine-learned model(s) 916 can be utilized to perform any of the operations utilized to manage the server(s) 102 and/or the data center 104 based on the block diagram 200 and the chart 300 and 400, as discussed above with reference to FIGS. 1-4.

In some examples, the machine-learned model(s) 916 can be trained (e.g., by the training computing system, as discussed below in further detail) utilizing any of the information managed (e.g., analyzed) by the machine-learned model(s) 916. Alternatively or additionally, the machine-learned model(s) 916 can be trained utilizing any information similar to, or different from, the information managed (e.g., analyzed) by the machine-learned model(s) 916.

For example, the machine-learned model(s) 916 can be or can otherwise include one or more of various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models. In some implementations, the one or more machine-learned model(s) 916 can be stored in the memory 910, and then used or otherwise implemented by the one or more processors 908. In some implementations, the client computing system 904 can implement multiple parallel instances of a single machine-learned model 916 (e.g., to perform parallel updated notification elements across multiple instances of user input data obtained via a structured user interface).

The server computing system 902 can obtain, from parameter database 918, parameter(s) 920. In some examples, the parameter database 918 can be utilized to implement the data center 104. In some examples, the server computing system 902 can store, obtain, retrieve, and/or manage the parameter(s) 920 via the parameter database 918. The parameter(s) 920 can include, and/or be utilized to obtain, generate, replace, provide, and/or manage, any of the information stored in the data stores 914.

The parameter(s) 920 can include information utilized to cause presentation of content at individual computing devices (e.g., any of the computing device(s) 118/120). Examples of content include input elements (e.g., the input elements 954, as discussed below in further detail) of various types, such as advertisements webpages, word processing documents, portable document format (PDF) documents, images, videos, search results pages, and feed sources. Native applications (e.g., “apps”), such as applications installed on the computing device(s) 118/120 are also examples of the input elements. Individual ones of the computing device(s) 118/120 can include mobile, tablet, desktop computing devices, any other types of devices, or any combinations thereof.

The server computing system 902 can communicate with other systems via network 922. For example, the server computing system 902 can communicate with the client computing system 904, the cloud provider computing system 906, one or more other systems, via the network 922. In such an example or another example, the server computing system 902 can communicate with the parameter database 918 directly (e.g., not utilizing the network 9220, and/or via the network 922.

In some examples, the MTA credit information 914K can include the credit(s) W(1,x) (with channel C) 310, the credit(s) W(2,x) (with channel C turned off) 314, one or more other types of credits, or any combination thereof. In some examples, the incrementality information 914L can include the incrementality information 108, the overall incrementality(ies) I(x) 406, one or more other types of incrementalities, or any combination thereof. In some examples, the MTA result information 914M can include the TEDDA information 106 (e.g., which can include the non-testing TEDDA result(s) Tx 404), the calibrated MTA information 110, the fully calibrated result(s) Nx 408, the calibrated results (x) 412, 414, and 416, one or more other results of various types, or any combination thereof. In some examples, the lever information 914N can include the lever information 112, the levers 1 utilized to calculate the calibrated results (x) 412, 414, and 416, one or more other types of levers, or any combination thereof.

The cloud provider computing system 906 can include processor(s) 924 and memory 926, which can be implemented in a similar way, and/or can perform similar operations as the processor(s) 908 and memory 910, respectively. The memory 926 can include data 926P and/or instructions 926Q, which can be implemented in a similar way, and/or can perform similar operations as, the data 910A and/or the instructions 910B, respectively.

The cloud provider computing system 906 can include an MTA calibration pipeline 928 and/or data stores 930, which can be implemented in a similar way, and/or can perform similar operations as the MTA calibration pipeline 912 and/or the data stores 914, respectively. The data stores 930 can include MTA credit information 930S, incrementality information 930T, MTA result information 930U, and lever information 930V, which can be implemented in a similar way, and/or can perform similar operations as, the MTA credit information 914K, the incrementality information 914L, the MTA result information 914M, and the lever information 914N, respectively.

The cloud provider computing system 906 can include one or more machine learned model 932, individual ones of which can be implemented in a similar way, and/or can perform similar operations as any of the machine learned model(s) 916. In some implementations, the machine-learned model(s) 932 can be received from the server computing system 902 over network 922, stored in the memory 926, and then used or otherwise implemented by the one or more processors 924. In some implementations, the cloud provider computing system 906 can implement multiple parallel instances of a single machine-learned model 932 (e.g., to perform parallel updated notification elements across multiple instances of user input data obtained via a structured user interface).

The client computing system 904 can include one or more processors 934 and memory 936, which can be implemented in a similar way, and/or can perform similar operations as the processor(s) 908 and memory 910, respectively. The memory 936 can include data 936Y and/or instructions 936Z, which can be implemented in a similar way, and/or can perform similar operations as, the data 910A and/or the instructions 910B, respectively. The client computing system 904 can include one or more user input components (also referred to herein simply as “input component(s)”) 938 that receive user input. In some embodiments, the user input components 938 can include, and/or be utilized to manage (e.g., identify, determine, modify, delete, etc., or any combination thereof), the user input elements, as discussed above. For example, a user input component 938 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some embodiments, the client computing system 904 can include user session data 940 indicative of a user session with a user device (e.g., the user device 944, as discussed below in further detail). The client computing system 904 can utilize the user session data 940 to provide session data descriptive of a plurality of user sessions. The plurality of user sessions respectively can include an interaction with individual ones of the input elements rendered at the user device and a request for a resource associated with the corresponding input element.

In some implementations, the client computing system 904 can store or include one or more machine-learned models 942. For example, the machine-learned model(s) 942 can be implemented in a similar way, and/or can perform similar operations as the machine-learned model(s) 916 and/or the machine-learned model(s) 932, and/or vice versa. In some implementations, the machine-learned model(s) 942 can be received from the server computing system 902 over the network 922, stored in the client computing system memory 936, and then used or otherwise implemented by the one or more processors 934. In some implementations, the client computing system 904 can implement multiple parallel instances of a single machine-learned model 942 (e.g., to perform parallel updated notification elements across multiple instances of user input data obtained via a structured user interface).

The content (e.g., the input elements) can be provided (e.g., by the server computing system 902, the client computing system 904, the cloud provider computing system 906, one or more other systems of various types, and/or any combination thereof) to a user device 944. In some examples, the user device 944, with which a user 946 (e.g., individual ones of the users 230-234) may be associated, can be utilized to implement the computing device(s) 118/120. In some examples, the user device 944 can be similar to, the same type as, different from, and/or of a different type than, the client computing system 904. Alternatively or additionally, a portion (e.g., a partial or entire portion) of the user device 944 may be implemented as, integrated and/or combined with, etc., a portion (e.g., a partial or entire portion) of the client computing system 904.

In various cases, one or more servers (e.g., the server computing system 902 the client computing system 904, and/or the cloud provider computing system 906, one or more other systems of various types, and/or any combination thereof) can include servers that host publisher websites. In this example, the user 946 can initiate a request for a given publisher webpage 948, 950, and/or 952, and the system(s) 902/904/906 can respond to the request by sending machine executable instructions that initiate presentation of the given webpage at the user device 944.

In another example, the system(s) 902/904/906 can include content servers including app servers from which user devices (e.g., the user device 944) can download apps. In this example, the user device 944 can download files required to install an app at the user device 944, and then execute the downloaded app locally. The app can present organic content, e.g., content specified by a developer of the app, and in some cases can also present one or more digital components (e.g., the input elements 954 including, and/or associated with touchpoints 956, content created/distributed by a third party) that are obtained from a digital component server (e.g., a database that is included in the system(s) 902/904/906, and/or to which the system(s) 902/904/906 are connected), and inserted into the app while the app is being executed at the user device 944.

The input elements 954 can include a variety of content. For example, an input element can include static content (e.g., text or other specified content) that is within the input element itself and/or does not change over time. Input elements can also include dynamic content that may change over time or on a per-request basis. For example, a publisher of a given input element can maintain a data source that is used to populate portions of the input element. In this example, the given input element can include a tag or script that causes the user device 944 to request content from the data source when the given input element is processed (e.g., rendered or executed) by a user device 944. The user device 944 may integrate the content obtained from the data source into the given input element to create a composite input element including the content obtained from the data source.

In some implementations an input element can include an input field. An input element can be configured to obtain user input via a user interface and generate user input signals. The input element can be configured to obtain user input signals and transmit (e.g., via a computing system) the user input signals to a server for processing. In some embodiments an input element could include a text box, touch screen, or other interactive user interface element. For example, the input element can include a clickable URL, clickable link, an item that when interacted with, causes the server to transmit additional content to the user (e.g., direct the user to an additional website).

In some embodiments, a given input element can include a digital component tag or digital component script that references the system(s) 902/904/906. In these situations, the digital component tag or digital component script is executed by the user device 944 when the given input element is processed by the user device 944. Execution of the digital component tag or digital component script configures the user device 944 to generate a request for digital components (referred to as a “component request”), which is transmitted over the network 922 to the system(s) 902/904/906. For example, the digital component tag or digital component script can enable the user device 944 to generate a packetized data request including a header and payload data. The component request can include event data specifying features such as a name (or network location) of a server from which the digital component is being requested, a name (or network location) of the requesting device (e.g., the user device 944), and/or information that the digital component distribution system can use to select one or more digital components provided in response to the request. A component request is transmitted, by the user device 944, over the network 922 (e.g., a telecommunications network) to a server of the system(s) 902/904/906.

The component request can include event data specifying other event features, such as the input element being requested and characteristics of locations of the input element at which the digital component can be presented. For example, event data specifying a reference (e.g., URL) to an input element (e.g., webpage) in which the digital component will be presented, available locations of the input elements that are available to present input elements (e.g., digital components, content items), sizes of the available locations, and/or media types that are eligible for presentation in the locations can be provided to the system(s) 902/904/906. Similarly, event data specifying keywords associated with the input element (“input element keywords”) or entities (e.g., people, places, or things) that are referenced by the input element can also be included in the component request (e.g., as payload data) and provided to the system(s) 902/904/906 to facilitate identification of input elements (e.g., digital components, content items) that are eligible for presentation with the input element. The event data can also include a search query that was submitted from the user device 944 to obtain a search results page, and/or data specifying search results and/or textual, audible, or other visual content that is included in the search results.

Component requests can also include event data related to other information, such as information that a user of the user device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests can be transmitted, for example, over a packetized network, and the component requests themselves can be formatted as packetized data having a header and payload data. The header can specify a destination of the packet and the payload data can include any of the information discussed above.

The system(s) 902/904/906, which can include one or more digital component distribution servers, can choose, and/or be managed (e.g., controlled) to choose, input elements (e.g., digital components, content items) that will be presented with the given input element in response to receiving the component request and/or using information included in the component request. In some implementations, a digital component is selected in less than a second to avoid errors that could be caused by delayed selection of the digital component. For example, delays in providing input elements (e.g., digital components, content items) in response to a component request can result in page load errors at the user device 944 or cause portions of the input element to remain unpopulated even after other portions of the input element are presented at the user device 944. Also, as the delay in providing the digital component to the user device 944 increases, it is more likely that the input element will no longer be presented at the user device 944 when the digital component is delivered to the user device 944, thereby negatively impacting a user's experience with the input element. Further, delays in providing the digital component can result in a failed delivery of the digital component, for example, if the input element is no longer presented at the user device 944 when the digital component is provided.

To facilitate searching of input elements, the environment 900 can include a search system that identifies the input elements by crawling and indexing the input elements (e.g., indexed based on the crawled content of the input elements). Data about the input elements can be indexed based on the input element with which the data are associated. The indexed and, optionally, cached copies of the input elements are stored in a search index (e.g., hardware memory device(s)). Data that is associated with an input element is data that represents content included in the input element and/or metadata for the input element.

User devices 944 can submit search queries to the search system over the network 922. In response, the search system can access the search index to identify input elements that are relevant to the search query. The search system can identify the input elements in the form of search results and return the search results to the user device 944 in the search results page. A search result may include data generated by the search system that identifies an input element that is responsive (e.g., relevant) to a particular search query, and includes an active link (e.g., hypertext link) that causes a client device (e.g., included in, or separate from, the client computing system 904) to request data from a specified location in response to user interaction with the search result. An example search result can include a web page title, a snippet of text or a portion of an image extracted from the web page, and the URL of the web page. Another example search result can include a title of a downloadable application, a snippet of text describing the downloadable application, an image depicting a user interface of the downloadable application, and/or a URL to a location from which the application can be downloaded to the user device 944. Another example search result can include a title of streaming media, a snippet of text describing the streaming media, an image depicting contents of the streaming media, and/or a URL to a location from which the streaming media can be downloaded to the user device 944. Like other input elements search results pages can include one or more slots in which digital components (e.g., advertisements, video clips, audio clips, images, or other digital components) can be presented. As described above, a variety of online content can be presented to users as they interact with online resources available through the Internet. That online content can generally be classified as organic content or digital components.

Organic content may include content that is specified by and/or provided by an owner or administrator of the online resource in which the content is being presented. Examples of organic content include search results provided by a search engine, and content presented in a web page provided by a publisher. In each of these examples, the content presented may be specified by the entity providing the online resource and may be therefore considered first party content. For example, the search engine can identify online resources relevant to a submitted search query, generate search results identifying those relevant resources, and generate a search results page (in the domain of the search engine) that includes the search results generated by the search engine. Thus, the search results may be generated by the search engine, and presented in the search results page generated by the search engine, thereby making the search results first party content, and thus, organic content. Similarly, when a user visits a particular web page, that web page may include content specified by and/or generated by the publisher of that web page, which may be also considered first party content, such as organic content, for purposes of the present discussion.

For purposes of this discussion, digital components may be considered third party content because the digital components may be created by and/or provided by an entity that differs from the entity providing the online resource on which the digital component is presented. In the context of a search results page, a digital component that includes third party content can be a digital component that is selected for inclusion in the online resource at the time the online resource may be presented (e.g., weather data, stock data, or advertisements). For example, a digital component (e.g., presenting current weather conditions, stock prices, or advertisements) can be selected by a third party (e.g., a different domain than the search engine domain) at the time a search results page is generated, and provided for presentation within the search results page. As discussed above, digital components presented with a search results page can be selected by an entity other than the entity providing the search results page based, at least in part, on the search query submitted by the user. In the context of a web page provided by a publisher (e.g., a blog, news web page, weather web page, stock information web page), a digital component provided by a third party that differs from the publisher of the web page can be selected for presentation in the web page when the web page is requested by a client device. The digital components selected for presentation with a given web page can be selected, for example, based on organic content of the given web page and/or characteristics of the user (e.g., interests, profile information, etc.) visiting the given web page.

Each exposure to an input element (e.g., content) can have an effect on a user's future online (or offline) activity. Individual ones of the exposures may be included as part of corresponding content associated with a corresponding channel (e.g., any of the channels 212-216). For example, a user that sees content related to a particular brand of shoe (e.g., reviews, news articles, or advertisements) may be more likely to acquire that particular brand of shoes than the user would have been absent from the exposures. In some situations, it can be advantageous to be able to quantify the effects of different content exposures as they relate to a user subsequently performing some specified target action 958.

In some examples, any target action 958 can be identified, defined, and/or represented as a conversion (e.g., any of the conversions 218-228). Additionally or alternatively, any target action 958 can be associated with individual ones of the conversions 218-228 in any other way.

In some implementations, the target action 958 can be specified by a digital component provider. For example, a digital component provider can specify that the target action 958 as one or more of the user downloading a white paper, navigating to at least a given depth of a website, viewing at least a certain number of web pages, spending at least a predetermined amount of time on a website or web page, completing a website registration process, subscribing to a digital service, adding items to shopping cart or purchasing a product. When a user performs a specified target action 958, performance of the specified target action 958 can be referred to as the conversion.

A user's performance of the specified target action 958 is often preceded by a series of exposures to online content (e.g., rendering of a content item on a user device, such as the user device 944, associated with a user, such as the user 946). For example, assume that the user 946 has interest in a particular camera and wants to know more about the camera. Further assume that a digital component provider that distributes digital components (e.g., content items, input elements) containing information about the particular camera has specified the target action 958 as acquisition of the particular camera.

In this example, the user 946 may view, identify, request, search for, and/or obtain content (e.g., media content, such as content associated with, and/or related to, the particular camera) (e.g., associated with individual ones of the channels, such as the channels 230-234), and/or information about the content, on the user device 944 by submitting one or more selections to individual ones of the system(s) 902/904/906 over the network 922. Individual ones of the selection(s) can include one or more requests, one or more queries, etc., any other type of selection, or any combination thereof. Individual ones of the system(s) 902/904/906 can identify one or more results responsive to the corresponding selection, and return the result(s) to the user device 944 for display.

The user 946 viewing the result(s) at the user device 944 can visit websites, and/or webpages 948, 950, 952, etc., to submit the selection(s) and/or receive the result(s) (e.g., by clicking on content presented by the user device 944 which each contain information about the particular content. Each of these visits to the websites, and/or webpages 948, 950, 952, etc., by the user 946 can also be considered exposures of content (e.g., organic content) to the user 946. Assuming that the user 946 ultimately acquires the particular camera (i.e., performs the specified target action 958), each of these exposures to organic content, referred to as organic events, will have contributed to the user's performance of the specified target action 958, and the relative contribution of these organic exposures can be quantified (e.g., as a conversion, such as any of the conversions 218-228) as described in more detail below.

In the example, above, it is assumed that the user 946 may have been exposed to organic content about the particular camera prior to performing the specified target action 958, but that the user 946 may have not been exposed to a digital component about the particular camera (e.g., a specified type of digital component). Exposures to digital components can also contribute to the user's performance of the specified target action 958. For example, assume that prior to performing the specified target action 958, the user 946 performs another search. Further assume that, in response to this search, the search system returns a search results page including search results, and a digital component server provides a digital component (e.g., an input element) about the particular camera for presentation with the search results.

In this example, when the user 946 subsequently performs the specified target action 958 (e.g., acquiring the particular camera), the user's exposure to the digital component will also have contributed to the performance of that specified target action 958. However, it may not be readily apparent, not directly observable, and/or difficult to determine the level of the effect of the digital component exposure as it relates to the user's subsequent performance of the specified target action 958. Moreover, it may not be readily apparent from raw data related to content exposures alone how to differentiate between the contributions of organic exposures and the contributions of exposures to digital components as they relate to influencing the user's subsequent performance of the target action 958. As such, it can be difficult to effectively and efficiently distribute content to users, particularly as it relates to input elements (e.g., digital components).

To determine the effects of content exposures as they relate to users performing a specified target action 958, the environment 900 can include the system(s) 902/902/906 being utilized to generate the incrementality information 108, the calibrated MTA information 110, and/or the lever information 112. By generating the incrementality information 108, the calibrated MTA information 110, and/or the lever information 112, the effectiveness, relevance, reliability, etc., of the exposures in the channels (e.g., the channels 212/214/216) can be determined.

In some examples, the machine-learned model(s) 916/932/942 can be trained to generate the exposures, and/or to manage the target action(s) 958, the incrementality information 108, the calibrated MTA information 110, and/or the lever information 112, and/or any information associated therewith. For instance, the machine-learned model(s) 916/932/942 can be trained utilizing a training computing system. The training computing system (e.g., and/or a machine-learned model included therein) may be configured to evaluate content exposures, and determine the level of contribution of each of those content exposures to users' subsequent performance of a specified target action 958.

Additionally or alternatively, the machine-learned model(s) 916/932/942 can be trained to determine the probability that by presenting input elements (e.g., content exposures) that a user is more likely to interact with (e.g., the system is more likely to obtain data indicative of a user interaction with a content item). Additionally or alternatively, the machine-learned model(s) 916/932/942 can be trained to determine how the limited user interface (e.g., screen space) can be used to optimize user input. Thus, the system(s) 902/902/906 can adapt a user interface of a computing device (e.g., the user device 944) to present items that are actually relevant to a user's tasks or goals for using the computing device.

As an example, user activity may provide one or more signals that a particular input element would be relevant to accessing a resource of interest or performing a task at hand. Information, such as the conversions (e.g., the conversion(s) 218-228) with which the target action(s) 958 are associated, can be used to determine the performance of specified type of digital components (e.g., input elements) distributed by the component distribution system. Additionally or alternatively, the performance of the digital components, such as for different geos (e.g., the geos 114/116), can be determined based on information (e.g., the channel(s) and/or the conversions 218-224) associated with the control geo 114), information (e.g., the channel(s) and/or the conversions 226-228) associated with the test geo 116, and/or comparisons therebetween.

The determined performances, and/or differences thereof/comparisons therebetween, can be used to improve the relevance of content presented to users, for example, by modifying transmission criteria that control when, where, or how digital components are transmitted for presentation to users. In some examples, modifications of how digital components are transmitted can be automated utilizing the system(s) 902/902/906, such as by utilizing the machine-learned model(s) 916/932/942. For instance, one or more channel characteristics, which may specify how digital components are transmitted, may be controlled by the system(s) 902/902/906. However, systems and methods of the present disclosure can, in some embodiments, determine that rendering that particular input element would not be of sufficient incremental value to effectively improve the user interface (e.g., the user already has access to or otherwise is already navigating toward the resource of interest).

As described in more detail below, the training computing system can be configured to implement data collection techniques that enable the training computing system to learn, for various geos (e.g., the control geo 114, the test geo 116, individual ones of other geos, or any combination thereof), relationships between user sessions and baseline performance levels of a specified target action 958 (e.g., levels at which users having certain attributes perform the specified target interaction). These relationships can be referred to as a baseline action model that can output a baseline performance level based on attributes input to the system. This baseline performance model can be a stand-alone model, or incorporated into a more complex model structure that also takes into account other data, as described in more detail below.

The baseline performance levels may represent the level of performance of the specified target action 958 in the absence of users being exposed to digital components of a specified type. For example, a particular baseline performance level can be created to represent a rate at which users acquire a particular type of shoe when those users have not been exposed to digital components distributed for a seller of that particular type of shoe. In such an example or another example, the digital components to which the users in the test geo 116 may not be exposed may be associated with, and/or provided within, the channel 216 (e.g., the channel C). The digital components associated with the channel 216 being withheld from the users in the test geo 116 due to the channel 216 being off may be utilized to identify that the relatively greater number of conversions (e.g., the conversions 218-224) occur for the control geo 114 than for the test geo 116, with the relatively fewer number of conversions (e.g., the conversions 226 and 228).

In a specific example, the baseline performance measure can be indicative of the portion of users having a certain set of attributes that will acquire the particular type of shoe without those users being exposed to advertisements for that particular type of shoe.

The data collection techniques implemented by the training computing system, and/or the machine-learned model(s) 916/932/942, may also enable the training computing system (e.g., the machine-learned model of the training computing system) and/or the machine-learned model(s) 916/932/942, to model the effects of various content exposures over time as it relates to users subsequently performing the specified target action 958. For example, the training computing system can create a model that quantifies an initial change in the portion of users that perform the specified target action 958 immediately following exposure to a particular type of content (e.g., organic content or a digital component).

The training computing system, the machine-learned model(s) 916/932/942, and/or the model possibly created thereby, may be utilized to identify differences between the control geo 114 (e.g., the channels 306 utilized for the control geo 114) and the test geo 116 (e.g., the channels 308 (e.g., with channel C turned off) utilized for the test geo 116). Alternatively or additionally, the created model may be utilized to identify differences between the conversions 218-224, and/or the credits 312, associated with the control geo 114; and/or the conversions 226 and 228, and/or the credits 314, associated with the test geo 116, respectively. This ability to delineate between the control geo 114 and the test geo 116 may be utilized to determine the incremental effects of each content exposure remaining at the time the specified target action 958 is performed, thereby providing an improved attribution model and/or geo-experiment technique, relative to traditional systems that are not able to delineate the relative contributions of each content exposure that remain when the specified target action 958 is performed.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted and/or described steps are merely illustrative and can be omitted, combined, and/or performed in an order other than that depicted and/or described; the numbering of depicted steps is merely for ease of reference and does not imply any particular ordering is necessary or preferred.

The functions and/or steps described herein can be embodied in computer-usable data and/or computer-executable instructions, executed by one or more computers and/or other devices to perform one or more functions described herein. Generally, such data and/or instructions include routines, programs, objects, components, data structures, or the like that perform particular tasks and/or implement particular data types when executed by one or more processors in a computer and/or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined and/or distributed as desired. In addition, the functionality can be embodied in whole or in part in firmware and/or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions and/or computer-usable data described herein.

Although not required, one of ordinary skill in the art will appreciate that various aspects described herein can be embodied as a method, system, apparatus, and/or one or more computer-readable media storing computer-executable instructions. Accordingly, aspects can take the form of an entirely hardware embodiment, an entirely software embodiment, an entirely firmware embodiment, and/or an embodiment combining software, hardware, and/or firmware aspects in any combination.

As described herein, the various methods and acts can be operative across one or more computing devices and/or networks. The functionality can be distributed in any manner or can be located in a single computing device (e.g., server, client computer, user device, or the like).

Aspects of the disclosure have been described in terms of illustrative embodiments thereof. Numerous other embodiments, modifications, and/or variations within the scope and spirit of the appended claims can occur to persons of ordinary skill in the art from a review of this disclosure. For example, one or ordinary skill in the art can appreciate that the steps depicted and/or described can be performed in other than the recited order and/or that one or more illustrated steps can be optional and/or combined. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure covers such alterations, variations, and/or equivalents.

What is claimed is:

1. A computer-implemented method, comprising:
performing a control geo-experiment and a test geo-experiment to find an incrementality value, wherein the control geo-experiment has a first channel on and a second channel on, and wherein the test geo-experiment has the first channel on and the second channel off;
determining a likelihood of the incrementality value being applicable to a multi-touch attribution (MTA) result;
determining a calibration lever based at least in part on the likelihood; and
determining an MTA calibration of the MTA result based at least in part on the incrementality value, the calibration lever, and results from the control geo-experiment and the test geo-experiment.

2. The computer-implemented method of claim 1, wherein the calibration lever is determined based at least in part on at least one of:
i) a level of similarity between a control market comprising corresponding first MTA credits and a test market comprising corresponding second MTA credits;
ii) a degree of resemblance between the test market used to establish the calibration lever and a non-testing market requiring calibration;
iii) a level of freshness of the MTA calibration; or
iv) a predicted probability of future MTA calibrations being different due to market trends.

3. The computer-implemented method of claim 1, further comprising:
calculating another MTA calibration based at least in part on the MTA result, a fully calibrated MTA, the incrementality value, and another calibration lever.

4. The computer-implemented method of claim 1, further comprising:
calculating a fully calibrated MTA result by multiplying the MTA result by the incrementality value;
calculating a difference of the MTA result subtracted by the fully calibrated MTA result; and
calculating another MTA calibration by subtracting, from the MTA result, a product of another calibration lever and the difference.

5. The computer-implemented method of claim 1, wherein:
the control geo-experiment is performed for a first geo,
the test geo-experiment is performed for a second geo, and
the first geo and the second geo are associated with a similarity metric that is less than a threshold.

6. The computer-implemented method of claim 1, wherein performing the control geo-experiment and the test geo-experiment occurs within a threshold time from previously performing a prior control geo-experiment and a prior test geo-experiment.

7. The computer-implemented method of claim 1, further comprising:
performing the control geo-experiment by turning the first channel on and the second channel on, and then turning the second channel artificially off.

8. The computer-implemented method of claim 1, further comprising:
determining the incrementality value by comparing a first credit associated with the first channel in the control geo-experiment and a second credit associated with the first channel in the test geo-experiment.

9. A computer system, comprising:
one or more processors; and
one or more transitory or non-transitory computer-readable media storing instructions that are executable to cause the one or more processors to perform operations, the operations comprising:
performing a control geo-experiment and a test geo-experiment to find an incrementality value, wherein the control geo-experiment has a first channel on and a second channel on, and wherein the test geo-experiment has the first channel on and the second channel off;
determining a likelihood of the incrementality value being applicable to a multi-touch attribution (MTA) result;
determining a calibration lever based at least in part on the likelihood; and
determining an MTA calibration of the MTA result based at least in part on the incrementality value, the calibration lever, and results from the control geo-experiment and the test geo-experiment.

10. The computer system of claim 9, wherein the calibration lever is determined based at least in part on at least one of:
i) a level of similarity between a control market comprising corresponding first MTA credits and a test market comprising corresponding second MTA credits;
ii) a degree of resemblance between the test market used to establish the calibration lever and a non-testing market requiring calibration;
iii) a level of freshness of the MTA calibration; or
iv) a predicted probability of future MTA calibrations being different due to market trends.

11. The computer system of claim 9, wherein the operations further comprise:
calculating another MTA calibration based at least in part on the MTA result, a fully calibrated MTA, the incrementality value, and another calibration lever.

12. The computer system of claim 9, wherein the operations further comprise:
calculating a fully calibrated MTA result by multiplying the MTA result by the incrementality value;
calculating a difference of the MTA result subtracted by the fully calibrated MTA result; and
calculating another MTA calibration by subtracting, from the MTA result, a product of another calibration lever and the difference.

13. The computer system of claim 9, wherein:
the control geo-experiment is performed for a first geo,
the test geo-experiment is performed for a second geo, and
the first geo and the second geo are associated with a similarity metric that is less than a threshold.

14. The computer system of claim 9, wherein performing the control geo-experiment and the test geo-experiment occurs within a threshold time from previously performing a prior control geo-experiment and a prior test geo-experiment.

15. The computer system of claim 9, wherein the operations further comprise:
performing the control geo-experiment by turning the first channel on and the second channel on, and then turning the second channel artificially off.

16. The computer system of claim 9, wherein the operations further comprise:
determining the incrementality value by comparing a first credit associated with the first channel in the control geo-experiment and a second credit associated with the first channel in the test geo-experiment.

17. One or more non-transitory computer readable media storing instructions that are executable by one or more processors to perform operations comprising:
performing a control geo-experiment and a test geo-experiment to find an incrementality value, wherein the control geo-experiment has a first channel on and a second channel on, and wherein the test geo-experiment has the first channel on and the second channel off;
determining a likelihood of the incrementality value being applicable to a multi-touch attribution (MTA) result;
determining a calibration lever based at least in part on the likelihood; and
determining an MTA calibration of the MTA result based at least in part on the incrementality value, the calibration lever, and results from the control geo-experiment and the test geo-experiment.

18. The one or more non-transitory computer readable media of claim 17, wherein the calibration lever is determined based at least in part on at least one of:
i) a level of similarity between a control market comprising corresponding first MTA credits and a test market comprising corresponding second MTA credits;
ii) a degree of resemblance between the test market used to establish the calibration lever and a non-testing market requiring calibration;
iii) a level of freshness of the MTA calibration; or
iv) a predicted probability of future MTA calibrations being different due to market trends.

19. The one or more non-transitory computer readable media of claim 17, wherein the operations further comprise:
calculating another MTA calibration based at least in part on the MTA result, a fully calibrated MTA, the incrementality value, and another calibration lever.

20. The one or more non-transitory computer readable media of claim 17, wherein the MTA result includes a time to event data driven attribution (TEDDA) result.
